(19) United States
(12) Patent Application Publication
(10) Pub. No.: US 2019/0052724 A1
(43) Pub. Date: Feb. 14, 2019

(54) SYSTEMS AND METHODS FOR ESTABLISHING A SAFE ONLINE COMMUNICATION NETWORK AND FOR ALERTING USERS OF THE STATUS OF THEIR MENTAL HEALTH

(71) Applicant: Ivan Tumbocon DANCEL, Ottawa (CA)

(72) Inventor: Ivan Tumbocon DANCEL, Ottawa (CA)

(21) Appl. No.: 16/101,664

(22) Filed: Aug. 13, 2018

Related U.S. Application Data
(60) Provisional application No. 62/545,007, filed on Aug. 14, 2017.

(51) Int. Cl. H04L 29/08; G06Q 50/00; H04L 29/06

(52) U.S. Cl. CPC H04L 67/306; H04L 63/0861; H04L 67/22; G06Q 50/01

(57) ABSTRACT

Systems and methods for providing a safe online environment for sharing emotions, for encouraging real world interactions, and for alerting to the status of a user's mental health are provided.

### BACKGROUND OF THE INVENTION

The internet has greatly facilitated communication between people all around the world. A common means of online communication today is through the use of various online communication environments (or social media platforms). Social media platforms such as Facebook, Twitter, Instagram, etc., have become extremely popular, especially among youth, and for some people are considered a necessity. Online interaction offers a great opportunity for people to connect and share various aspects of their lives from a distance. However, the online space can also be plagued with cyberbullies, trolls, sexual predators, criminals etc., that often use fake accounts to allow them to operate without any accountability for their actions.

Another growing concern with online interaction is the potential to get addicted to using one's technological device and to spend too much time interacting in the digital world and not enough time in the real world. Studies suggest that technological addiction leads to decreased social skills and lower overall levels of mental health.

Current social media platforms' efforts to prevent predators, cyberbullies, fake accounts, etc., fall short of what is necessary to ensure a safe environment for users where they can be comfortable sharing their true emotions. Furthermore, social media companies do little to encourage non-digital (i.e. real world) interactions as it is in their best interests to have their users spend the maximum amount of time possible on their platforms.

Accordingly, there is a need for improved systems and methods that allow for the administration of an online communication platform that provides a safe environment for sharing true emotions, encourages real world interactions, and can help detect early signs of deteriorating mental health.

### SUMMARY OF THE INVENTION

In order to protect the online communication environment (OCE) against undesirable activities such as, for example, cyberbullying, trolling, fake accounts, fake news, sexual predators, and/or criminal activities, it is desirable to follow a strict registration process that allows accurate association between the accounts being created and the end users controlling them. Such accurate association helps ensure that end users exhibiting undesirable behaviour be held accountable for their actions by, for example, getting banned from the environment and effectively prevented from re-registering. As will now be explained in more detail, end users will be required to provide more than simply a valid email account and/or telephone number in order to be permitted to participate in the online communication environment.

In accordance with an embodiment of this disclosure, designated partners are used to help authenticate associated users requesting participation in the OCE. Designated partners may include, for example, educational institutions, medical institutions, private/public companies, organizations, government bodies, health professionals, or any other person or organization that may wish to participate. Users associated with those partners may include, for example, students, patients, employees, organization members, and etc. There may be multiple designated partners, all with the responsibility of authenticating users associated to them in various ways described below. Although not strictly required, it is preferable that end users request access to the OCE through their associated partner.

The strict registration process described herein involves obtaining a unique identifier associated to a unique end user/person. Every time a potential end user is requesting to access the OCE through a designated partner, the end user's unique identifier will be obtained and checked against the repository/database of end users that have already requested access to the OCE. Provided the unique identifier doesn't already exist in the repository/database, the user will be permitted access to the OCE. Conversely, if their unique identifier already exists, they will not be able to create a new account.

An end user unique identifier may, for example, be their fingerprint, facial biometric data, iris scan data, DNA, American Social Security Number, Canadian Social Insurance Number, banking information, etc. . . . . Multiple unique identifiers may be utilized if deemed necessary to accurately validate requesting end users.

### BRIEF DESCRIPTION OF THE FIGURES

Certain embodiments of the methods and systems are presented in the following disclosure with reference to:

FIG. 1, which is a schematic of an exemplary communications network which may be used to carry out the systems and methods of the present disclosure;

FIG. 2, which is a flowchart of exemplary steps to set up a designated partner for use within the strict registration tool/app;

FIG. 3, which represents a simple representation of a JSON structure related to the OCE registration administrator;

FIG. 4, which is a flowchart of exemplary steps an end user may follow to gain access to the OCE platform;

FIG. 5, which is a flowchart of exemplary steps that may be followed to implement the strict registration process;

FIG. 6, which is a depiction of an exemplary “create a Tick” page within the OCE;

FIG. 7, which is represents a simple representation of a JSON structure related to the creation of Ticks;

FIG. 8, which is a depiction of an exemplary “profile” page within the OCE;

FIG. 9, which is an exemplary schematic illustrating average happiness values associates with various hashtags;

FIG. 10, which is a depiction of an exemplary “home” page within the OCE;

FIG. 11, which is a depiction of an exemplary “stats” page within the OCE;

FIG. 12, which is demonstrative schematic related to the calculation of various happiness levels;

FIG. 13, which represents a simple representation of a JSON structure related to the stats kept in relation to a given country;

FIG. 14, which represents a simple representation of a JSON structure related to the stats kept in relation to a given hashtag;

FIG. 15, which is a depiction of an exemplary “following” page within the OCE;

FIG. 16, which is a depiction of an exemplary “search” page within the OCE;

FIG. 17, which is a depiction of an exemplary “rewards” page within the OCE;

FIG. 18, which represents a simple representation of a JSON structure related to rewards coupons;

FIG. 19, which is a flowchart of exemplary steps that may be followed to earn a reward using the OCE app;

FIG. 20, which is a flowchart of exemplary steps that may be followed to establish the context detection system for a victim-offender relationship;

FIG. 21, which represents a simple representation of a JSON structure related to the context detection system;

FIG. 22, which is a flowchart of exemplary steps that may be followed by the context detection system in order to determine whether content is abusive;

FIG. 23, which is a demonstrative schematic related to an exemplary methodology for detecting context within a video content;

FIG. 24, which is a flowchart of exemplary steps that may be followed by a moderator to determine the content of a video content;

FIG. 25, which is a flowchart of exemplary steps that may be followed by end users to earn rewards for performing real world interaction challenges;

FIG. 26, which illustrates how the end users' devices may interact with the database to allow the necessary monitoring of the proximity of the end users while performing a real world interaction challenge;

FIG. 27, which the OCE rewards administrator may interact with the database and end users' devices in order to effectively administer the interaction Rewards database node;

FIG. 28, which represents a simple representation of a JSON structure related to an exemplary depression detection system; and

FIG. 29, which is a partial depiction of an exemplary user interface of the OCE app or platform showing a possible visual indicator related to an end user's mental health state.

FIG. 30, which is a depiction of an exemplary graphical user interface page within the OCE for parents being invited to join the OCE;

FIG. 31, which is a simple representation of a JSON structure;

FIG. 32, which is a simple representation of a JSON structure;

FIG. 33, which is a simple representation of a JSON structure;

FIG. 34, which is a simple representation of a JSON structure;

FIG. 35A, which depicts an exemplary page within the OCE for displaying the content of a user's Tick;

FIG. 35B, which is a simple representation of a JSON structure;

FIG. 36A, which depicts an exemplary page within the OCE where a user can leave a comment to a Tick;

FIG. 36B, which is a simple representation of a JSON structure;

FIG. 37A, which depicts an exemplary page within the OCE where a user can review comments to their Tick that have been left by other users;

FIG. 37B, which is a simple representation of a JSON structure;

FIG. 38, which depicts an exemplary page within the OCE for displaying a list of comments to be reviewed and validated by a parent or guardian;

FIG. 39, which depicts an exemplary page within the OCE for displaying a specific comment for review and validation by a parent;

FIG. 40, which depicts an exemplary page within the OCE for displaying the points balance and max points earned for a user;

FIG. 41, which is a simple representation of a JSON structure;

FIG. 42, which is a simple representation of a JSON structure;

FIG. 43, which is a flowchart of exemplary steps for administering a recess challenge according to the present disclosure.

### DETAILED DESCRIPTION OF THE INVENTION

In order to protect the online communication environment (OCE) against undesirable activities such as, for example, cyberbullying, trolling, fake accounts, fake news, sexual predators, and/or criminal activities, it is desirable to follow a strict registration process that allows accurate association between the accounts being created and the end users controlling them. Such accurate association helps ensure that end users exhibiting undesirable behaviour be held accountable for their actions by, for example, getting banned from the environment and effectively prevented from re-registering. As will now be explained in more detail, end users will be required to provide more than simply a valid email account and/or telephone number in order to be permitted to participate in the online communication environment.

In accordance with an embodiment of this disclosure, designated partners are used to help authenticate associated users requesting participation in the OCE. Designated partners may include, for example, educational institutions, medical institutions, private/public companies, organizations, government bodies, health professionals, or any other person or organization that may wish to participate. Users associated with those partners may include, for example, students, patients, employees, organization members, and etc. There may be multiple designated partners, all with the responsibility of authenticating users associated to them in various ways described below. Although not strictly required, it is preferable that end users request access to the OCE through their associated partner.

The strict registration process described herein involves obtaining a unique identifier associated to a unique end user/person. Every time a potential end user is requesting to access the OCE through a designated partner, the end user's unique identifier will be obtained and checked against the repository/database of end users that have already requested access to the OCE. Provided the unique identifier doesn't already exist in the repository/database, the user will be permitted access to the OCE. Conversely, if their unique identifier already exists, they will not be able to create a new account.

An end user unique identifier may, for example, be their fingerprint, facial biometric data, iris scan data, DNA, American Social Security Number, Canadian Social Insurance Number, banking information, etc. . . . . Multiple unique identifiers may be utilized if deemed necessary to accurately validate requesting end users.

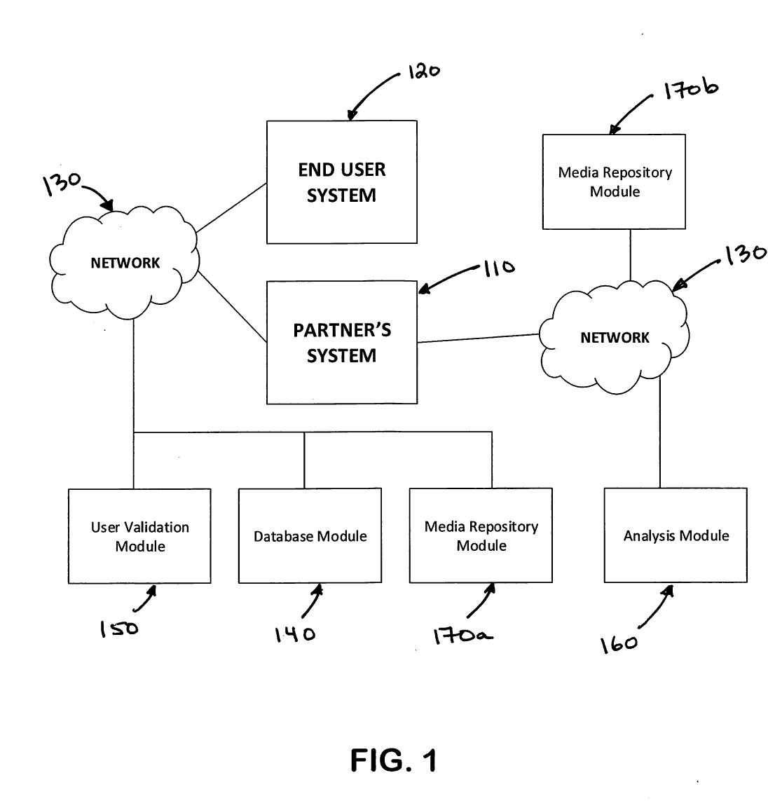

As an illustrative and non-limiting example, the strict registration process using facial biometric data as a unique identifier and an educational institution as a designated partner will now be described with reference to FIGS. 1-5. As would be known to those skilled in the art, alternative unique identifiers and designated partners may be substituted in the example below to achieve the same result.

The exemplary network configuration depicted in FIG. 1 illustrates how the various systems and modules involved in the OCE are connected to allow for performance of the various functions described throughout this disclosure. A designated partner's system 110 and an end user's system 120 both have access, via a network 130, to a database module 140, a user validation module 150, and a media repository module 170a. Additionally, the partner's system 110 has access, via a network, to an analysis module 160 and a second media repository module 170b for running the strict registration process when requesting and validating end user access to the OCE. This illustrative example contemplates the use of Google Firebase with Authentication, RealTime Database (“RT Database”), and Cloud Storage as the user validation module 150 database module 140 and media repository module 170a, respectively; and. Amazon AWS with Rekognition and S3 Storage as the analysis module 160 and media repository module 170b. Those skilled in the art will appreciate that other suitable similar modules may be used alternatively. Both the end user and the designated partner have access to the authentication, database and storage modules 140, 150, 170a. Additionally, the partner's system 110 has access to an analysis module 160 and a media repository module 170b.

The partner's system 110 may be an Android mobile device for example that has a camera, internet connection, and the Strict Registration Tool/App, described in more detail below, installed that they use to invite end users. The end user's system 120 may also be, for example, an Android device with an application for accessing the OCE installed on it. Multiple different unique partners can simultaneously have access to the analysis module 160 and media repository module 170b. The process through which a designated partner invites end users to participate in the OCE is described in detail further below.

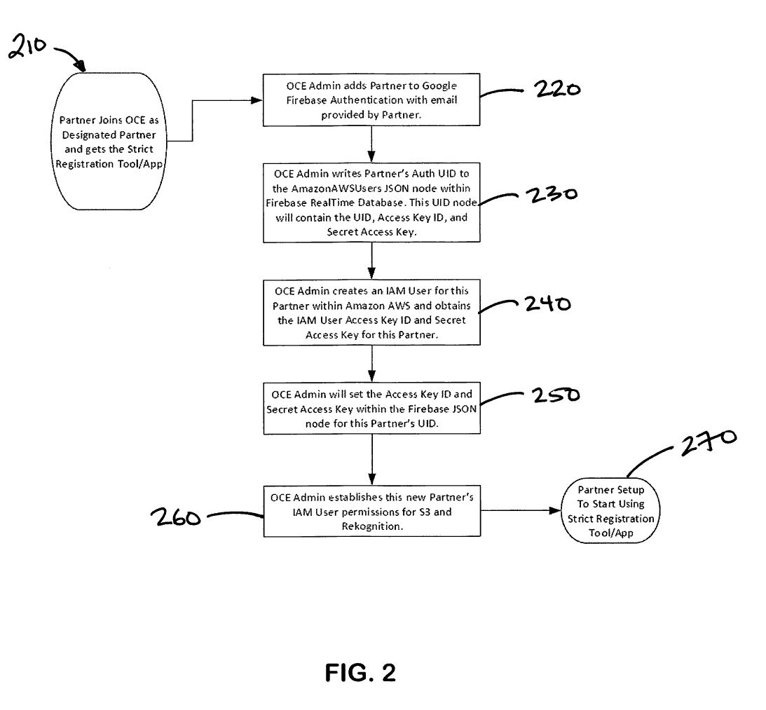

Use of the strict registration tool/app provided to the designated partner by the OCE registration administrator requires the designated partner to be added to Google Firebase and Amazon AWS. FIG. 2 shows the steps required to enable a designated partner to start using the strict registration tool/app to invite end users to participate in the OCE. Note that the OCE registration admin can either be a human, a non-human or combination of both.

With reference to FIG. 2, the first step 210 involves an educational institution joining the OCE as a designated partner and installing the strict registration tool/app on their system. The designated partner is required to provide an email address upon partnering with the OCE. At step 220, the OCE registration administrator adds the designated partner to Google Firebase Authentication using the email address provided. A default password for the designated partner is included at this step and Google Firebase creates an AuthUID for the designated partner.

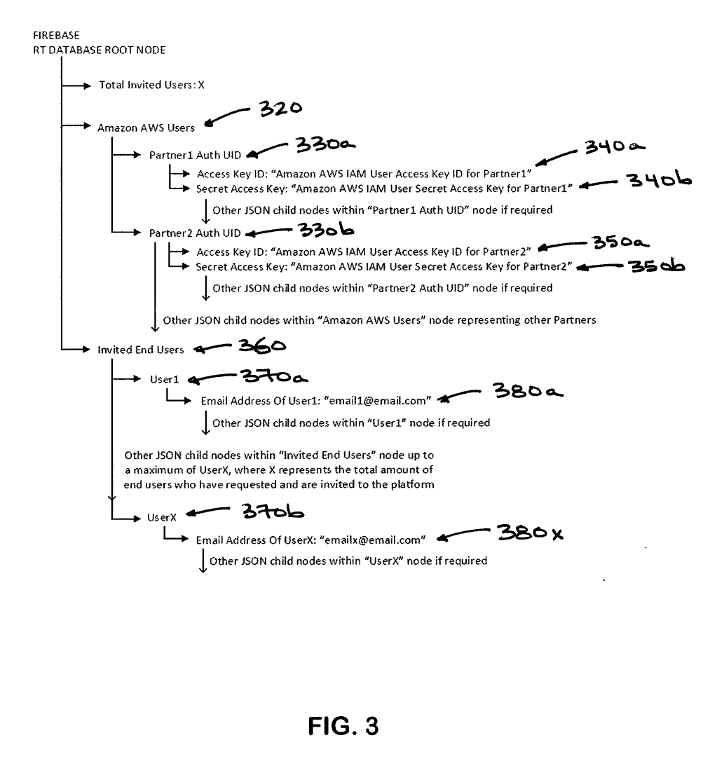

At step 230, the OCE registration administrator adds the designated partner's AuthUID to the AmazonAWSUsers JSON node within the Firebase RT Database (the JSON structure is described in more detail below with reference to FIG. 3). This node will contain the AuthUID, an access key ID and secret access key. By default, the access key ID and secret access key are set to blank strings and kept as place holders. At step 240, the OCE registration administrator creates a user profile (IAMUser) for the designated partner within Amazon AWS using the AWS Identity and Access Management service. This will permit the OCE registration admin to give the partner programmatic access to Amazon AWS services. Upon creating the IAM User for the designated partner, the OCE registration administrator obtains an access key ID and secret access key for this partner.

At step 250, the OCE registration administrator writes the newly acquired access key ID and secret access key to the JSON node created for the partner in step 230. At step 260, the OCE registration administrator establishes the new designated partner's IAM User permissions for S3 and Rekognition. Once step 260 has been completed, the partner is setup and may begin using the strict registration tool/app, as indicated at step 270.

A simple representation of a JSON structure that the OCE registration administrator will be required to use will now be described with reference to FIG. 3. As noted previously, although Google's Firebase RealTime Database structure is used for the purpose of illustration, this disclosure should not be interpreted to be limited to this database structure. As those skilled in the art would appreciate, various other suitable database structures and types may be used to achieve the same result.

As illustrated in FIG. 3, the JSON structure may include nodes corresponding to Amazon AWS Users (i.e. designated partners) 320 and Invited End Users 360. Within the Amazon AWS Users node, there may be multiple child nodes representing designated partners. Each designated partner will have a separate PartnerAuthUID node 330a, 330b. Within each PartnerAuthUID node is stored pertinent information including, for example the Access Key ID 340a, 350a, the Secret Access Key 340b, 350b and any other information deemed pertinent and required by the OCE registration administrator. Within the Invited End Users node, there may also be multiple child nodes representing end users that have been invited to participate in the OCE. Each end user will have a separate User node 370a, 370b. Within each User node is stored pertinent information including, for example the email address corresponding to the end user 380a, 380x. Other pertinent information relating to the end user may also be stored here.

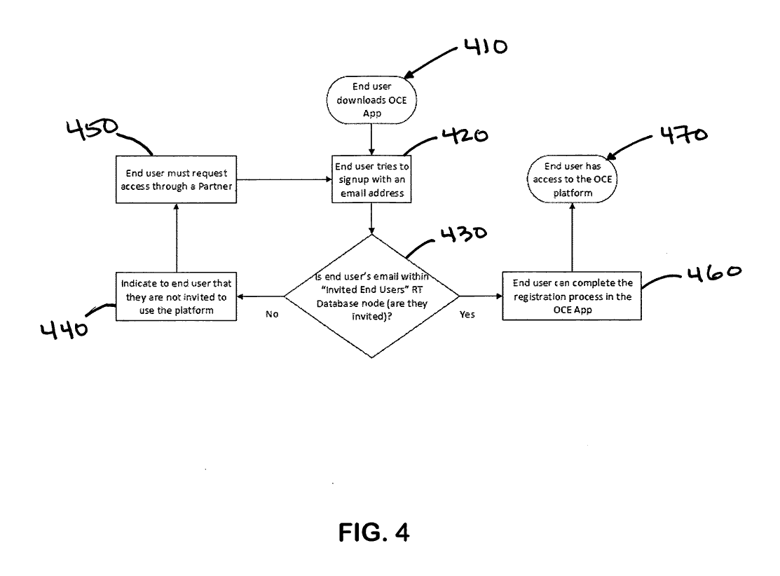

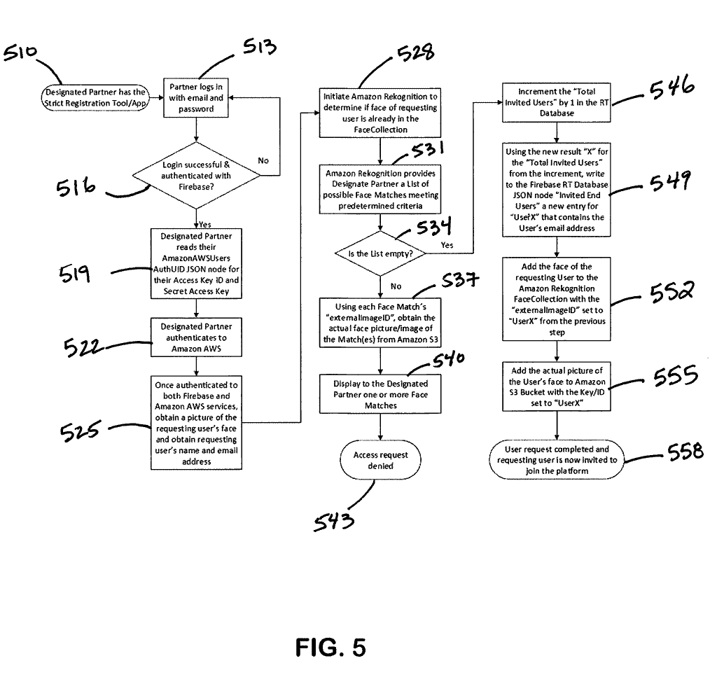

The steps required for an end user to gain access to the OCE will now be described with reference to FIG. 4. Beginning with step 410, a potential end user installs and opens the OCE application on their system or accesses the OCE platform via a web browser. At step 420, the potential user is prompted to sign up by entering his or her email address. Step 430 evaluates whether the email address provided by the potential user is present within the “Invited End Users” RT Database node 360 (FIG. 3). If the provided email address is not included within the “Invited End Users” RT Database, the user has yet to be invited to participate in the OCE and step 440 is triggered. At step 440, the end user is advised that they have not been invited to use the platform and that access must be requested through a designated partner (step 450). If the potential user then requests and is granted access to the platform by a designated partner (in accordance with the procedure detailed in FIG. 5), the partner would add the potential user's email to the “Invited End Users” RT Database node so that the next time around, this potential user's email would be found at step 430 and step 460 would be triggered. At step 460, the end user completes the registration process in the OCE application or online platform via web browser and the end user is granted access to the OCE platform 470. Completing the registration process may include offering the end user the ability to change their first and last name from what was registered via the strict registration tool/app of the designated partner. Additionally, the end user may be able to select a unique @username (similar to popular social media platforms), and be able to select a profile picture, for example, from their device storage, another 3^{rd} party app or by taking a new picture with their device. Once the end user has completed the registration process, they may be brought to a screen that has a user interface (UI) where they are able to interact with other end users.

If the decision step 430 is answered in the affirmative, Firebase will create an AuthUID for the end user and they will effectively be authenticated to Google Firebase. If, on the other hand, the end user is not yet invited from the decision point check, the potential user must request access through a partner. The decision matrix for granting an invitation will now be described in more detail with reference to FIG. 5.

At step 513, the designated partner logs in with their email and password. Step 516 evaluates whether the login is successful, i.e. whether the designated partner provided a valid and recognized email and password. If not, for example because the partner input the email and/or password incorrectly, the designated partner can try to login again. If the partner is authenticated in Firebase, step 519 is triggered. At step 519, the designated partner, through their device, reads their AmazonAWSUsers AuthUID JSON node for their access key ID and secret access key. At step 522, the designated partner uses their access key ID and secret access key from step 519 to authenticate to Amazon AWS. At step 525, the partner obtains a picture of the requesting end user's face, their name and email address. At step 528, Amazon Rekognition is initiated to determine if the face of the requesting end user is already in the database of faces of all past requesters of the OCE (this would indicate that the requesting end user had already requested an invitation through a designated partner). In the case of Amazon Rekognition, the facial database is known as FaceCollection. Determination of whether the face of the requesting end user is already in FaceCollection is done based on a predetermined and pre-set threshold. At step 531, Amazon Rekognition provides a list of possible face matches where each face match in the list contains an “externalImageID” associated to it. Each face match in the list is not the actual picture of a person's face. Rather, each face match contains “data” relating to the person's face, as is known in the art. Each face match in the list meets the given threshold criteria. The size of the list meets the given maximum number of results that Amazon Rekognition should return back. Per step 534, if the returned list is empty, i.e. there were no matching faces in the facial database, step 546 is initiated and the “Total Invited Users” is incremented by 1 in the RT Database using Firebase Transactions for example. At step 549, using the new result “X” for the “Total Invited Users” from the increment, a new entry for “UserX” that contains the user's email address is written to the Firebase RT Database JSON node “Invited End Users” (refer additionally to 360, 370b in FIG. 3). At step 552, the face of the requesting user is added to the Amazon Rekognition FaceCollection with the “externalImageID” set to “UserX” from step 549. At step 555, the actual picture of the requesting user's face is added to Amazon S3 Bucket with the key/ID set to “UserX” from step 549. Once step 555 has been completed, the requesting user has been accepted and is now invited to join the platform.

In the event at step 534, the list of possible face matches returned by Amazon Rekognition is not empty, i.e. there is at least one potential match in the FaceCollection, the actual picture/image of each returned match is retrieved from Amazon S3 using each of the externalImageID for each match in the returned list, as indicated at step 537. At step 540, the images retrieved are displayed to the designated partner. The images may, for example, be displayed in descending similarity percentage or alternatively, only the image of the face with the highest degree of similarity may be displayed. Having reached this step, the request is denied. That is, the designated partner will not be able to add the requesting user to the FaceCollection, S3, and Firebase as it has been determined that they already exist in the collection of face records, i.e. this requesting user has already been invited to participate in the OCE, possibly by another designated partner. This is demonstrated at step 543.

In the example above, “UserX” within the RT Database will map to the “externalImageID”=“UserX” for Amazon Rekognition FaceCollection and to the key/id of the image object as “UserX” for Amazon S3 Bucket. For example, in Amazon S3, the location of the image object may be http://s3.amazonaws.com/ocebucket/UserX.

Those skilled in the art may appreciate that it may be desirable to implement certain Google Firebase rules for the RT Database. For example, it may be desirable to have a rule that ensures that designated partners only be permitted to read their own AmazonAWSUsers Auth UID node so that no one else can access their AmazonAWS Access Key ID/Secret Access Key. Another desirable rule may be one that ensures that the entire Invited End User JSON node can be read by unauthenticated end users to ensure that when they are first trying to sign up without having been authenticated, they are able to read the Invited End User JSON node to check if their email address exists within the node.

The example provided in this disclosure uses Amazon Rekognition for facial biometrics as the unique identifier, however, those skilled in the art will appreciate that other unique identifiers may be utilized to similarly protect against various forms of abuse of the OCE. Other unique identifier techniques that may be utilized include currently available fingerprint scanning (e.g. Futronic FS88) and matching methods, available for example from NeuroTechnology's VeriFinger SDK, that may be integrated into/with the strict registration tool/app. Additional methods may include: lie detector techniques; a token that can map to database data that identifies the individual trying to request access to the OCE (for example, token “ABC” may map to user John Smith of Denver Colo. SIN #111 222 333); serial/model numbers associated with devices loaned by designated partners to their associated users (e.g. smartphone, tablets, chromebooks, laptops, etc. . . . given to students by their school for use while they remain a student); or any other technique that can accurately detect whether a requesting user has previously held an account in the OCE.

It may also be desirable to use multiple unique identifier techniques simultaneously. For example, since facial biometrics for a given person may change over time, it may be desirable to use a second unique identifier such as a fingerprint in order to prevent with greater certainty the creation of undesirable or duplicate accounts. The important part of the use of unique identifiers is to ensure as much as possible that a user is only permitted to register for the OCE one time throughout their lifetime.

The exemplary embodiment described herein incorporates designated partners to assist with the strict registration process. Although it would be possible to eliminate the designated partners and have end users issue participation requests directly to the OCE registration administrator, the use of designated partners helps to better ensure that the unique identifier being obtained from the requesting end user is valid and accurate. It is also contemplated that a designated partner could be a corporate body dedicated specifically to registrant validation, similar to for example a municipal transportation department that is charged with issuing driver's licenses.

When using designated partners to assist with the strict registration process, it may be desirable for an AI or human moderator (or combination of both) to check the quality of how the partner administers the strict registration tool/app. The AI or human moderator may view a live video, for example, to ensure that the partner is taking the necessary precautions to verify, for example, that the requesting end user is not wearing facial prosthetics to potentially fool the strict registration process.

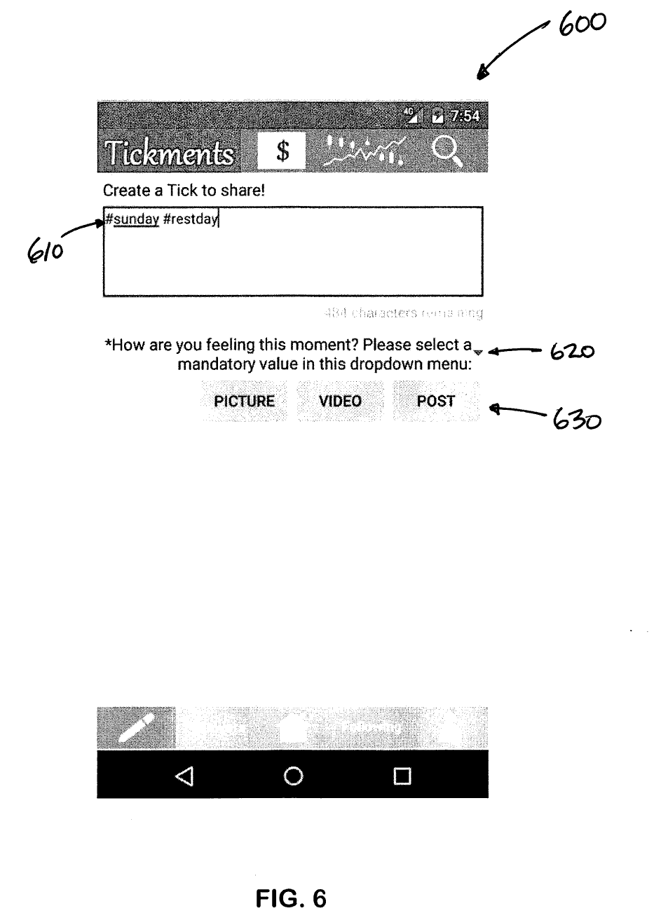

Through the use of the strict registration tool/app described above, a safer online communication environment may be achieved by ensuring a higher integrity level of users on the platform and by more effectively preventing sanctioned offending users from re-registering. In turn, this safer environment allows and encourages users to share their emotions with others and in turn receive and provide emotional support from and to their friends. With this, users are able to empathize with each other and can teach people the benefits of being empathetic and kind to others. The following portion of the disclosure describes, with reference to FIGS. 6 to 17, the layout of an OCE platform in accordance with an embodiment of the present disclosure in greater detail. The layouts in FIGS. 6, 8, 10, 11, 15, 16 and 17 are only visible to those users that have been successfully authenticated, for example with Firebase, and registered for participation in the OCE.

FIG. 6 shows a visual representation of the “Create Tick” page 600. The Create Tick page allows end users to share how sad or happy they feel through the posting of a message 610, otherwise known as a Tick. Ticks may contain: only text with hashtags, mentions, emojis, etc . . . ; only an image; only a video; or any combination thereof.

The platform utilizes a scale that equates to the end user's happiness level called the Tick Value. In the example of FIG. 6, a user is prompted to select a tick value associated with his or her message from drop down menu 620. Possible choices for the tick value may range from zero (extremely sad) to 10 (extremely happy) and may be limited to integers. Since every end user is different and may have a different perception of what happy is, as an alternative to prompting the user to select a tick value on their own, an Artificial Intelligence service may be called on to determine the sadness or happiness level of the Tick created. With this, the perception of an end user will be normalized and standardized to everyone else's so that the Tick can have a true relative value from a scale of 0 to 10.

Methods of using AI to extract the sentiment of a Tick will now be described briefly in more detail. Further detail on the use of certain currently available AI technologies is provided later in the disclosure in the paragraphs relating to context detection of Ticks.

As previously mentioned, Ticks may contain any combination of text, image and video. For the text portion of a Tick, currently available technology services may be utilized, such as for example Google Cloud Natural Language API, to detect the sentiment of the text. The Natural Language API returns back a result ranging from −1.0 (negative) to 1.0 (positive). Therefore, a result of −1.0 could represent a Tick Value of zero (0) and a result of 1.0 could represent a Tick Value of ten (10). Results in between −1.0 and 1.0 may correspondingly equate to Tick Values between 0 and 10 based on a predetermined mapping algorithm.

In the case of images, available technology such as for example Google's Cloud Vision API may be used to first extract words, labels and other properties from the Image. Using these words and labels, and the Tick's actual Text (if applicable), the Natural Language API may be used to return back a result ranging from −1.0 (negative) to 1.0 (positive) to assign a Tick Value to the Tick in a similar fashion as described for pure text Ticks.

In the case of videos, available technology such as video AI may be used to extract words, labels and other properties from the videos, which can then be combined with the Tick's actual text (if applicable) and sent to the Google Cloud Natural Language API for analysis. Again, the Natural Language API returns back a result ranging from −1.0 (negative) to 1.0 (positive) and the Tick is assigned a Tick Value in a similar fashion as described for text.

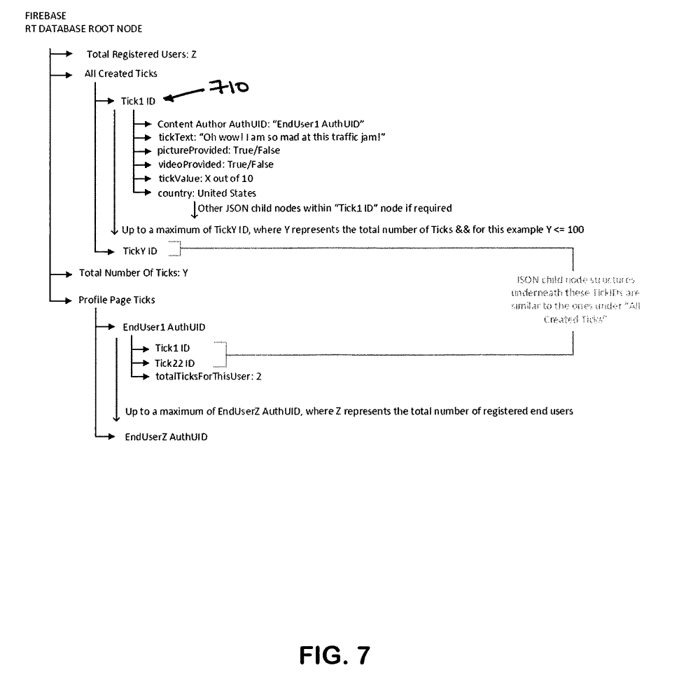

Once the end user has input a message, a tick value has been assigned (either by selection by the end user or determination by an OCE moderator or by AI), and the Post button 630 has been pressed, the information is sent from the OCE app or platform to RT Database and if applicable Cloud Storage to save the image or video included with the Tick. When a Tick is created, a TickID 710 may be generated to ensure that each Tick created worldwide has a unique id. In this case, all Ticks would be associated to their specific TickID. Content images and videos saved in Cloud Storage are also associated to their specific TickID. For example, an image may be stored in Cloud Storage as “ABCXYZ.jpg”, where “ABCXYZ” represents a unique TickID. A simplified JSON structure for the RT Database to store Ticks is illustrated in FIG. 7. When a Tick is created, the OCE app or platform writes to more JSON nodes that are not shown in the simplified diagram. In the interest of clarity, only a subset JSON nodes relevant to the topics being described are represented in the simplified diagrams. Note that one of the reasons for using Cloud Storage is because it is common industry practice to store files such as images and videos to a “storage bucket”. The RT Database is not a “storage bucket”.

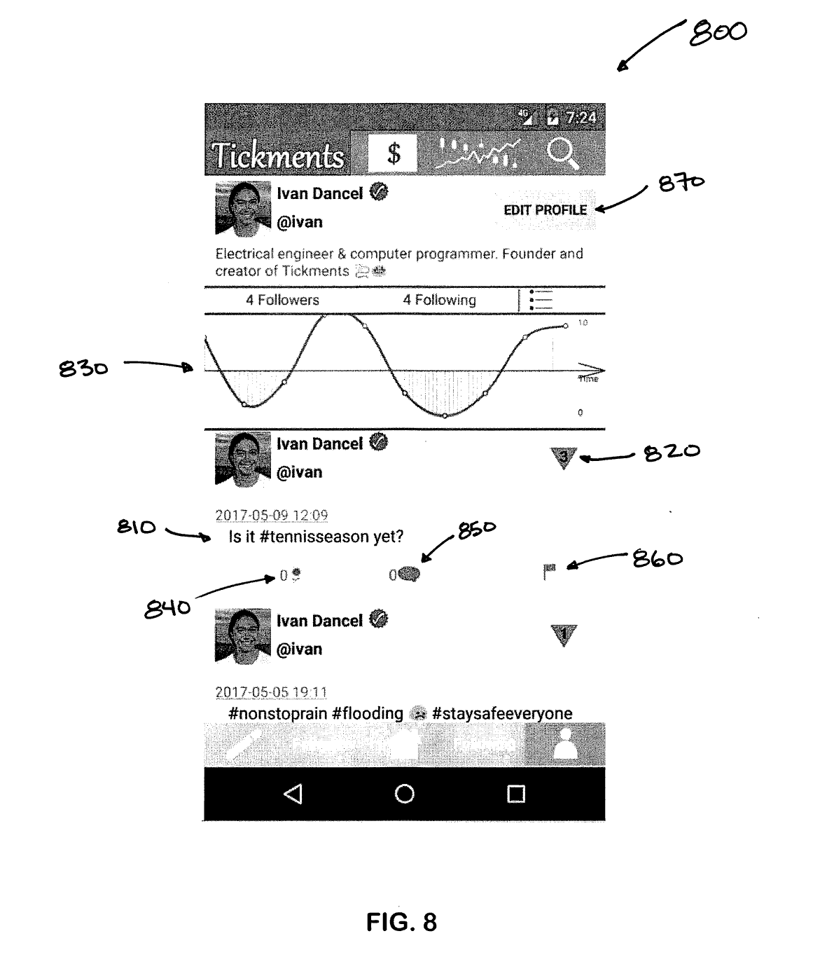

FIG. 8 shows a visual representation of a profile page 800 for a given end user. For the profile page, the end user may be viewing their own profile or they could be viewing another end user's profile. Regardless, the OCE app or platform will read the RT Database location that houses the Ticks.

Referring back to the Create Tick page and simplified JSON diagram of FIGS. 6 and 7, when any user creates a Tick, the OCE app or platform writes to numerous RT Database locations to save all and relevant information. In addition to writing to the All Created Ticks JSON node, the OCE app or platform may also write to the user's own AuthUID JSON node within the Profile Page Ticks JSON node. The user's total Ticks may then be incremented by 1.

Therefore, when an end user is viewing the profile of UserX within the profile page, the OCE app or platform will read the RT Database→Profile Page Ticks→EndUserX AuthUID JSON node that corresponds to UserX whose profile is being viewed within the profile page. By reading the proper JSON node, the individual Ticks are obtained and displayed to end users (see for example numeral 810). Using the TickID for each Tick, the images and videos can also be retrieved from Cloud Storage and displayed to the end user, if applicable.

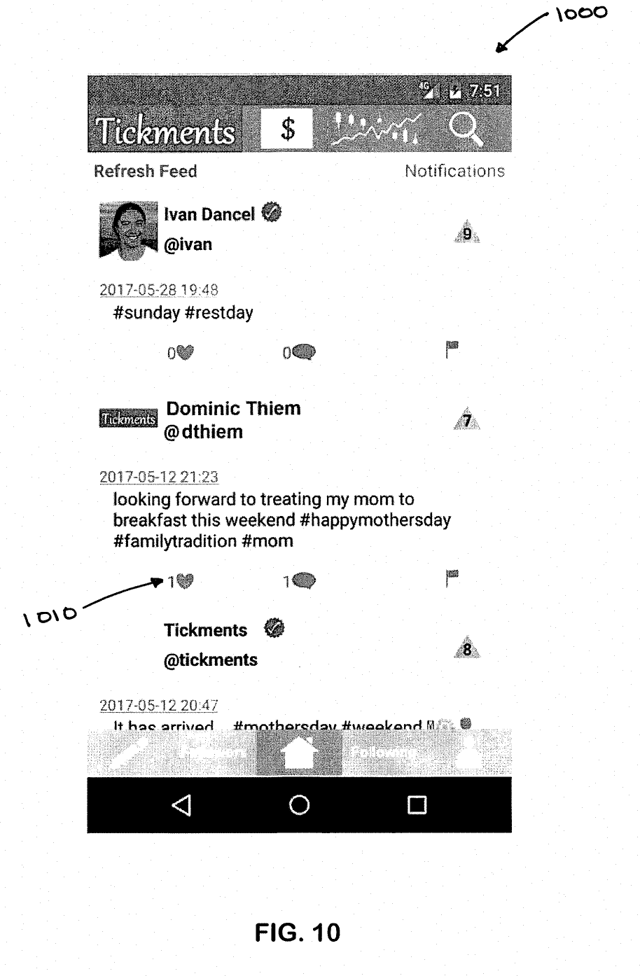

Beside each Tick may be displayed its corresponding Tick Value 820. As an additional visual representation, Tick Values less than 5 may be displayed inside a downward pointing red triangle (e.g. 820), such as the Ticks illustrated in FIG. 8. Similarly, Tick Values of 6 or more may be displayed in an upward pointing green triangle (such as those shown in FIG. 10), and a Tick Value of 5 may be displayed in a grey square. These types of visual representations allow a user viewing a Tick to more rapidly assess whether that particular Tick was sad (or negative), happy (or positive), or neutral in nature.

Tick Values may also be used to create and display a chart 830 to the end user to show the emotional swings of the person they are viewing.

Additional icons may be displayed along each Tick. For example, a flower icon 840 may be displayed next to a sad or neutral Tick (i.e. Tick Value of 5 or less), which when clicked on by a user signifies to the Tick's poster that the user wishes to cheer the poster up. A heart icon may be displayed next to a happy Tick (i.e. Tick Value of 6 or more) which may be clicked on to show the poster that you like their Tick. A chat bubble icon 850 may be provided next to a Tick of any value to allow users to leave a comment responsive to the Tick. And a red flag icon 860 may be provided next to a Tick of any value to allow users to click on it to report the Tick if they believe it violates the OCE rules and code of conduct.

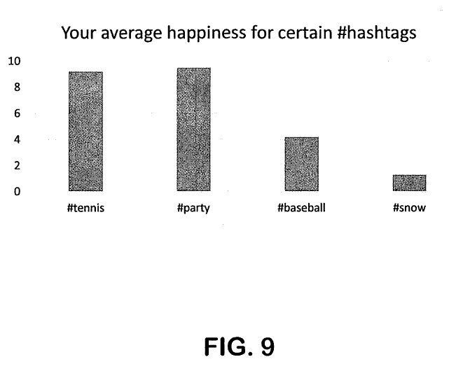

Within the profile page 800, there may be a visual button labelled “Edit Profile” 870 that allows the end user to change their profile biography and set their status as either a Public User or a Private User. Within the profile page 800 as well, there may be a visual button that leads the end user to view detailed analytics of their emotion with respect to certain hashtags/themes. FIG. 9 illustrates an example of a Reflection Analysis feature. This pictorial may only be viewed by end users about themselves and typically wouldn't be viewable to other users, friends, or followers. It may, however, be desirable to allow designated partners to access this feature about their associated users.

FIG. 10 shows a visual representation of a home feed page 1000 for a given end user

Similarly to the profile page 800, home feed page 1000 displays Ticks. Unlike profile page 800, however, home feed page 1000 displays the latest Ticks of the other users that the profiled end user is following in addition to their own. The JSON nodes are not illustrated in the Create Tick JSON diagram of FIG. 7, however, the end user who is viewing his or her home feed page will have a list of people they are following saved in RT Database under a Following JSON node. Each Following user has saved their latest TickID in RT Database. Using this aggregated information, the OCE app or platform can download from the All Ticks Created JSON node and display the proper Ticks in the home feed page for the end user to view.

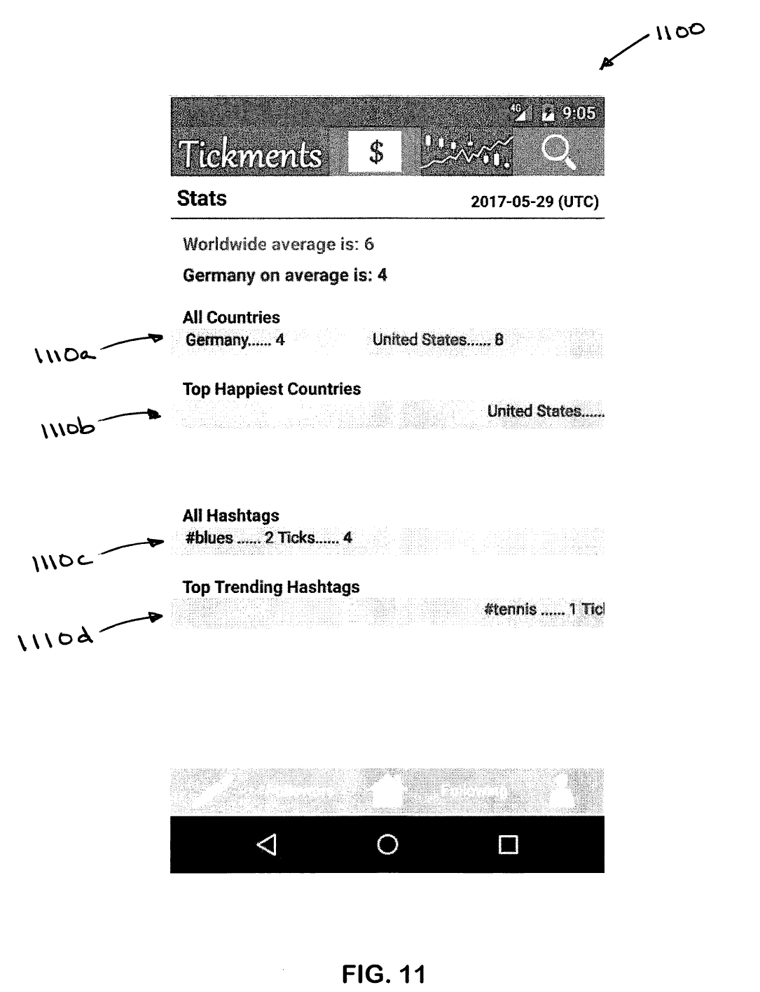

FIG. 11 shows a visual representation of a statistics page 1100. The stats page 1100 may incorporate certain visual elements of a typical stock market ticker for publicly traded companies for a given day. For example, there may be an animation that sweeps the happiness level of countries and trending hashtags 1110a, 1110b, 1110c, 1110d from right to left across the screen of a user's device when viewing the stats page. Happiness levels of different countries may be obtained, for example, by determining the average Tick Value using all Ticks from users in a given country on a given day. Upon creating of a Tick, the country where the end user is located may be determined using location permissions and services (e.g. GPS, WiFi, cell). When a tick is sent to be saved in the corresponding RT Database JSON nodes, there will also be RT Database write operations to the Country Stats JSON node→day in question→country in question whereby the averageTickValue, totalRunningTickValue, and totalUsersPosted will be updated based on the newly created Tick.

Ticks with an associated Tick Value may also include hashtags. Therefore, when a tick is sent to be saved in the corresponding RT Database JSON nodes, there will also be RT Database write operations to the HashtagStats JSON node→day in question→hashtag in question whereby the averageTickValue, totalRunningTickValue, and totalUsersPosted will be updated based on the newly created Tick.

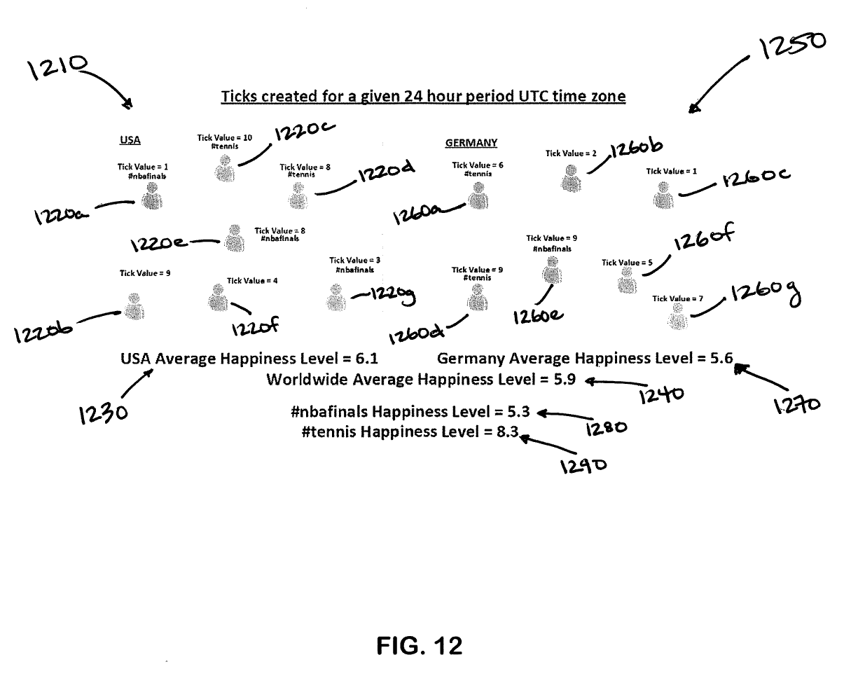

A given day used in the OCE app or platform is a 24 hour period anchored to UTC (Coordinated Universal Time) time zone. FIG. 12 illustrates how the happiness value for different countries and hashtags may be obtained. Two groups of Ticks are visually depicted in FIG. 12, one group coming from users residing in the United States 1210 and another group from users residing in Germany 1250. Each individual mark within the groups 1220 and 1260 represents an individual Tick from that country and has an associated Tick Value and in some cases hashtag. In the case of the happiness of a given country, an average may be taken of all of the Ticks within the group of Ticks for that country. In the example illustrated in FIG. 12, the average happiness level for the USA 1230 of 6.1 is calculated considering all of the Ticks designated 1220. Similarly, the average happiness level for Germany 1270 of 5.6 is calculated considering all of the Ticks designated 1260. A worldwide average happiness level 1240 may also be calculated considering all Ticks on a given day (i.e. regardless of country of origin). Worldwide average happiness level 1240 of 5.9 was calculated considering all of the Ticks 1220 and 1260.

When calculating a happiness level for a hashtag, all Ticks associated with the given hashtag are considered, regardless of country of origin. In the example illustrated in FIG. 12, the average happiness for the hashtag #nbafinals 1280 of 5.3 is calculated considering all Ticks associated with #nbafinals 1220a, 1220e, 1220g, 1260e. Similarly, the average happiness for the hashtag #tennis 1290 of 8.3 is calculated considering all Ticks associated with #tennis 1220c, 1220d, 1260a, 1260d.

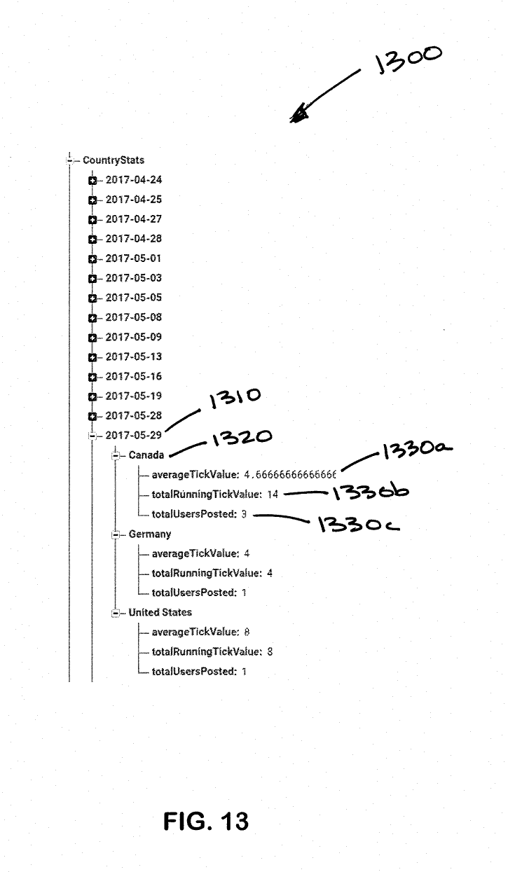

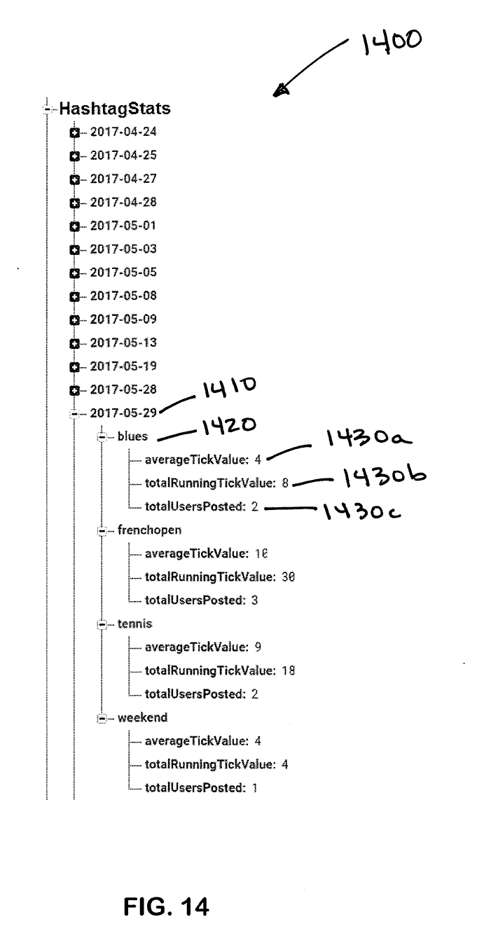

For further clarity, sample JSON node structures (independent of the example illustrated in FIG. 12) are included in FIGS. 13 and 14 where the happiness levels are written to and retrieved from the RT Database. For the sample country stats JSON node 1300 depicted in FIG. 13, there is a node for every day 1310, with a child node for each country 1320 represented by user Ticks from that day. For each country child node, there may be further child nodes corresponding to, for example, average tick value 1330a, total running tick value 1330b, and total users posted 1330c. A similar JSON structure may exist for the hashtag stats, whereby a node is created for every day 1410, with a child node each hashtag 1420 represented by user Ticks from that day. For each hashtag child node, there may be further child nodes corresponding to, for example, average tick value 1430a, total running tick value 1430b, and total users posted 1430c.

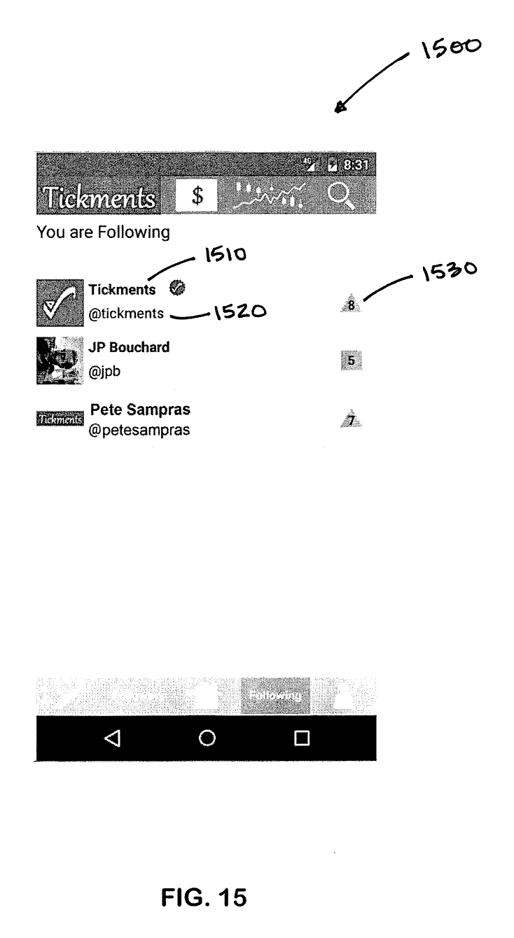

FIG. 15 shows a visual representation of a following page 1500. The following page indicates to the user which other users he or she has selected to follow. Various information, including for example the name corresponding to the account 1510, the username 1520, and the most recent Tick Value 1530 may be displayed in connection with each user that is being followed. Alternatively, for users that have selected to be a Private User the latest Tick Value may only be displayed to those followers that have been selectively approved by the private user.

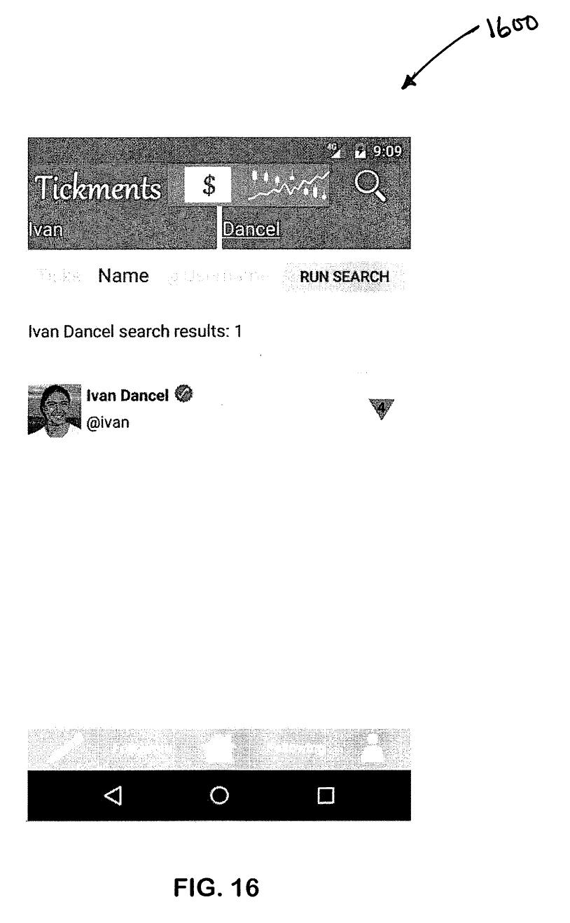

FIG. 16 shows a visual representation of a search page 1600. From the search page, users may search for specific #hashtags and other end users by name or @username. Similar to the followers page of FIG. 15, the latest Tick Value is displayed next to those users returned by the search results. Again, for users that have selected to be a Private User the latest Tick Value may only be displayed to those followers that have been selectively approved by the private user.

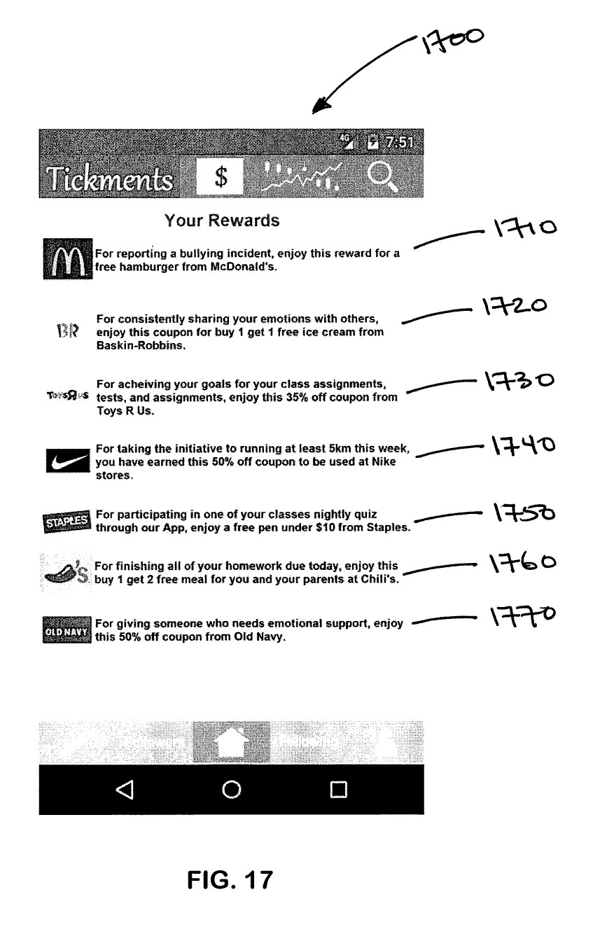

FIG. 17 shows a visual representation of a rewards page 1700. The Rewards Page allows end users to view the rewards/coupons that they have earned while engaging with the OCE. The rewards page may be a relatively non-intrusive way to offer products and services to users. Rather than bombard the user with potentially irrelevant and annoying advertisements, it may be up to the end user to click on the rewards page icon to view the rewards/coupons they have earned.

The companies permitted to offer coupons/rewards to end users may be limited to those that share the vision of the OCE app or platform so that end users will be provided only with rewards/coupons that they truly need and that, for example, promote a healthy lifestyle or positively contribute to education needs. Such necessities may include for example food, clothing, educational materials, medicine, entertainment, transportation, and etc. The example rewards page of FIG. 17 depicts two types of engagement within the OCE. The first is engagement with other end users (1710, 1720, 1770), which may be satisfied for example by posting and sharing Ticks, reporting abusive content such as cyberbullying, providing emotional support to friends, etc. . . . . The second is engagement with their associated designated partner (1730, 1750, 1760) such as completing all their assigned homework due for a given day, achieving target test and assignment results, participating in nightly trivia/quiz with their teacher/classmates, etc. . . . . Additionally, users may be rewarded for performing healthy activities outside of the OCE, such as running 5 km in a week 1740.

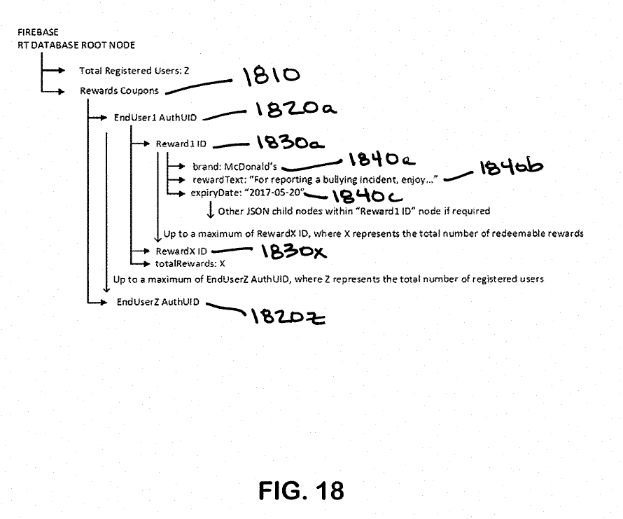

In the case of engagement with other users within the OCE, there may be an OCE rewards administrator that will review and scan the RT Database for the end user's engagement. For example, the OCE rewards administrator may check the end user's Profile Page Ticks JSON node to determine how often the end user shares Ticks to their friends. The OCE rewards administrator may then write to the specific end user's RewardsCoupons JSON node (further described below with reference to FIG. 18) within the RT Database for the end user to redeem when it is determined that the end user has met specific criteria for different scenarios of engagement with friends within the OCE.

In the case of engagement with an associated designated partner, the partner may be responsible to verify each end user's participation/interaction. For example, an educational partner may check the homework completion of a particular student end user. With the end user's successful participation/interaction, the partner may write to the RT Database RewardsCoupons JSON node for the end user to redeem provided that the end user has met specific criteria for different scenarios of engagement with the associated partner.

In order to keep track of the partner associated to each user, there may be data representing that association in the RT Database. For example, in the example of an education institution (call them ABC High School) designated partner, a student end user who attends ABC High School will be associated to ABC High School. This association may be obtained in many ways, such as for example retrieving the location where the end user spends most of their day time with their mobile device (this requires permission to use location services). Alternatively, the student end user may be called on to tap their mobile device to the partner's device (for example Android phone to Android phone), and via near field communication (NFC), the student end user is then associated to the specific partner school.

An additional type of behaviour that may be rewarded involves engagement with strong social ties such as close friends and family (as opposed to weaker social ties such as acquaintances and strangers). This type of reward-warranting behaviour will be discussed in more detail further on in this disclosure.

FIG. 18 shows a simplified JSON node structure for RewardsCoupons within the RT Database. The rewards page will need to read the specific end user's AuthUID JSON node within the RewardsCoupons JSON node in order to list and display the available rewards/coupons that the end user can redeem.

As illustrated in FIG. 18, a Rewards Coupons node 1810 may be utilized to keep track of coupons/rewards earned by each end user. Within the Rewards Coupons node, there are individual child nodes for each end user 1820a, 1820z. Within each End User node, there may be multiple child nodes for rewards 1830a, 1830x. Within each reward node may be store information pertinent to the reward earned by the end user. Such information may include for example the company or brand offering the reward 1840a, a text string to be displayed on the end user's rewards page describing the reward and the reason it is being offered 1840b, and an expiry date 1840c, if appropriate. The OCE rewards administrator may also be called on to delete certain “RewardX ID” once the expiry date has passed. Additionally, the OCE rewards administrator (or any other OCE administrator) may do an automated maintenance operation and delete certain RewardX IDs that have expired.

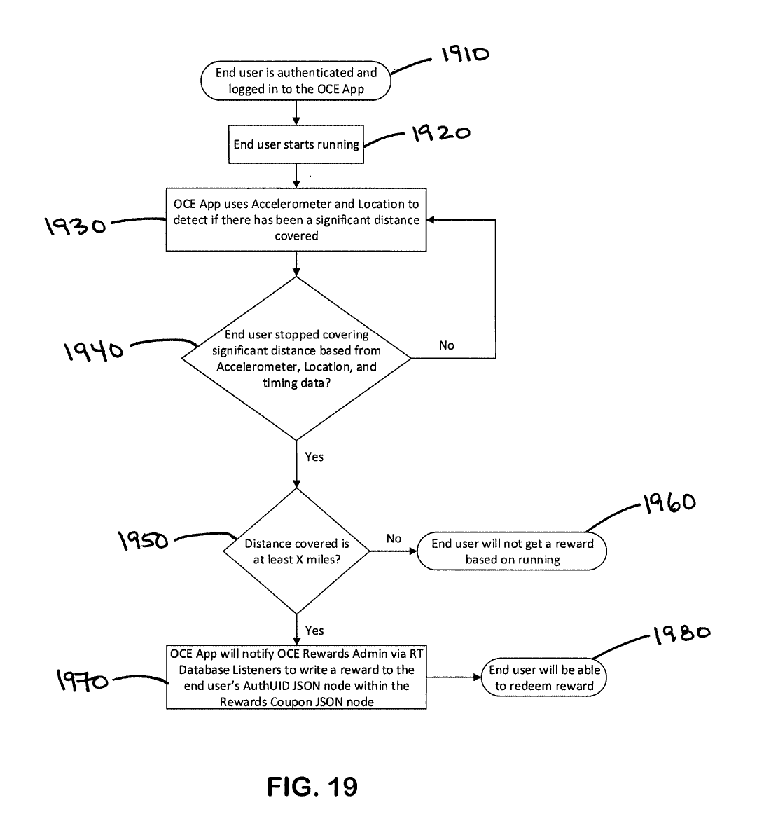

The determination of whether a reward is warranted in response to a physical activity having been performed (in this example a run of a set distance) will now be further discussed with reference to the block diagram contained in FIG. 19. The process starts from the assumption that the end user is authenticated and logged into the OCE app on the mobile device 1910. The end user then begins running 1920. Accelerometer, location and time data from the end user's mobile device is used to determine whether the end user is continuously running 1930. Readings of the accelerometer, location and time data are continuously taken at set intervals until it is determined that the end user has stopped covering a significant distance over a particular interval 1940, i.e. he or she has stopped running. Once it has been determined that the user has stopped running, a determination is made whether the distance covered meets the distance required to earn the reward 1950. The distance, for example, could be set at 5 miles. If the calculated distance is less than the distance required to earn the reward, it is determined at step 1960 that the user will not be offered the reward based on their run. Alternatively, if the calculated distance is greater than the distance required to earn the reward, the OCE app will notify the OCE rewards administrator, via the RT Database Listeners, to write a reward to the end user's AuthUID JSON node within the RewardsCoupons JSON node 1970. The user will then be able to redeem the reward earned 1980 by accessing his or her rewards page.

One important aspect of the safe OCE app or platform discussed throughout this disclosure is the ability to ensure that the environment is free from abusive content such as, for example, bullying messages. In order to achieve a safe environment, that app or platform must be able to monitor shared content, remove abusive content, and hold authors of the abusive content accountable for their actions. In the context of the OCE described herein, content may be a Tick, Comments, Profile Biographies, etc. . . . . A context detection system for monitoring content within the OCE and ensuring that obvious and non-obvious forms of bullying and abuse are effectively addressed throughout the OCE app or platform.

Firstly, any content shared in the OCE platform and visible to an end user may be reported to one or more OCE moderators by the viewing end user. Recall that content created by Private Users may only be visible to approved followers of the Private User, but any end user may view the content of Public Users regardless if they are an approved follower of the Public User or not.

An OCE administrator or moderator may also take the initiative and review any content that is not reported by end users. This may be part of a maintenance operation to possibly supplement the reporting initiatives of end users. The OCE moderator(s) may be human operators, non-human, or a combination of both, and would typically have full access to all content regardless of whether said content was created by a Private User or Public User. For content that is obviously abusive/offensive by nature, the OCE moderator(s) can simply deduce whether the content must be removed or not and can decide an appropriate sanction to issue to the offender. Sanctions may include, for example, issuing a warning, banning the offender from the OCE, or imposing restrictions of the offender's ability to participate in the OCE. For example, content that contains hate speech towards a particular religious denomination is easily detectable and may be promptly removed with the offending user being ultimately banned, disabled, etc. . . . from the OCE. Other forms of obvious abuse include for example sexism, racism, homophobia, threats and insults. There are also forms of abuse that are relatively unobvious such as, for example, name-calling, mocking and teasing, and intimidation.

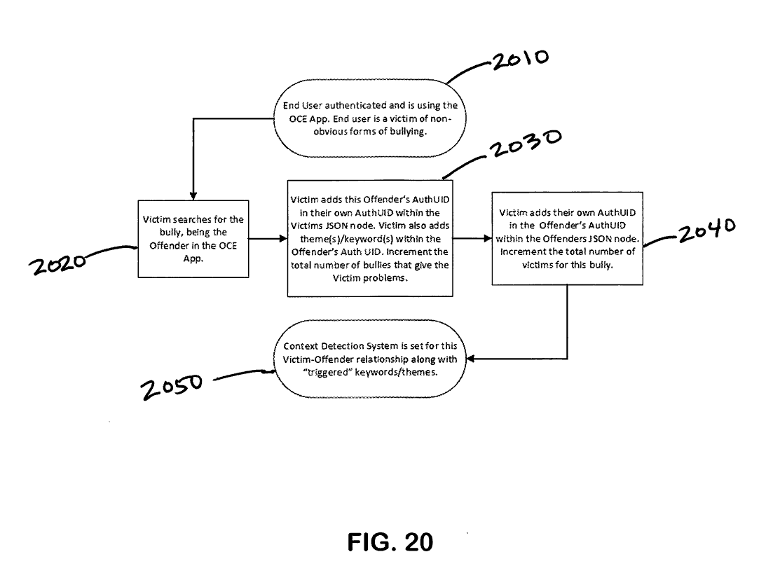

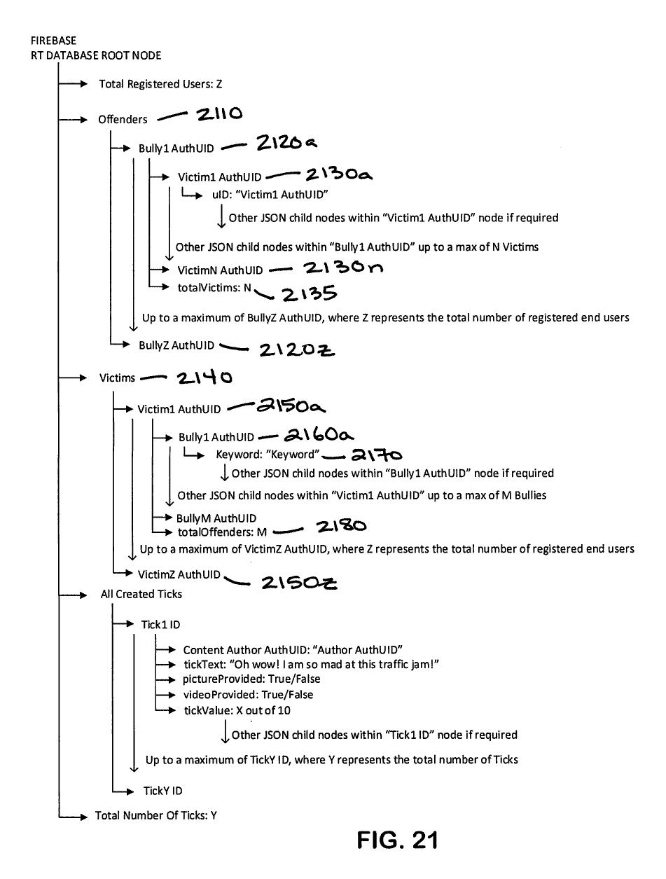

For non-obvious content, OCE moderator(s) may assess the context of the content using a context detection system to check whether the content contains certain theme(s)/keyword(s) that a targeted end user may be sensitive to. As an illustrative non-limiting example, consider the word “browny”, which can imply an edible food, or can be used by a bully to name-call a foreign Indian student at their school. The context detection system used by the OCE moderator(s) may rely on the certain theme(s)/keyword(s) identified by the victim as being terms that they are sensitive to. Victims may have the ability to add these theme(s)/keyword(s) within the OCE platform. Given the list of sensitive theme(s)/keyword(s), the context detection system will assist the OCE moderator(s) in their role of determining whether a non-obvious bullying incident has occurred in the OCE platform. The process through which a victim may identify a potential bully and associated theme(s)/keyword(s) will now be described in greater detail with reference to FIGS. 20 and 21. The example is being provided for illustrative purposes and should not be interpreted as limiting the scope of this disclosure.

The process begins at step 2010 with an authenticated end user using the OCE platform who is a victim of non-obvious forms of bullying. At step 2020 the victim searches for the bully (i.e. the offender) using the search function of the platform (FIG. 16). Once the offending user is found, the victim identifies this user as an offender and indicates one or more theme(s)/keyword(s) that the victim is sensitive relating to this particular offender 2030. If this is the first offender identified by this victim, a Victims JSON node 2150a will be created for this victim user using the victim's AuthUID, and a child Bully JSON node 2160a will be created (using the offender's AuthUID) within this victim's JSON node 2150a. The theme(s)/keyword(s) identified by the victim with respect to this offender will be included in a child node 2170 within the Bully node 2160a. A running total of bullies 2180 that affect a particular victim is kept and incremented every time a new bully is added to the Victim node associated with that victim user. If this victim user has previously identified an offender, their Victim node 2150a will already be present in the JSON structure and will not need to be re-written. Identification of the offender by the victim also causes (at step 2040) the victim user's AuthUID 2130a to be written in the Offenders node 2110 under a node associated with the identified offender/bully 2120a. In the example previously provided, where a bully in High School XYZ is name-calling a victim within the school using the term “browny”, the victim user may add the keyword “browny” in their list of sensitive theme(s)/keyword(s) which will then be mapped to that particular bully.

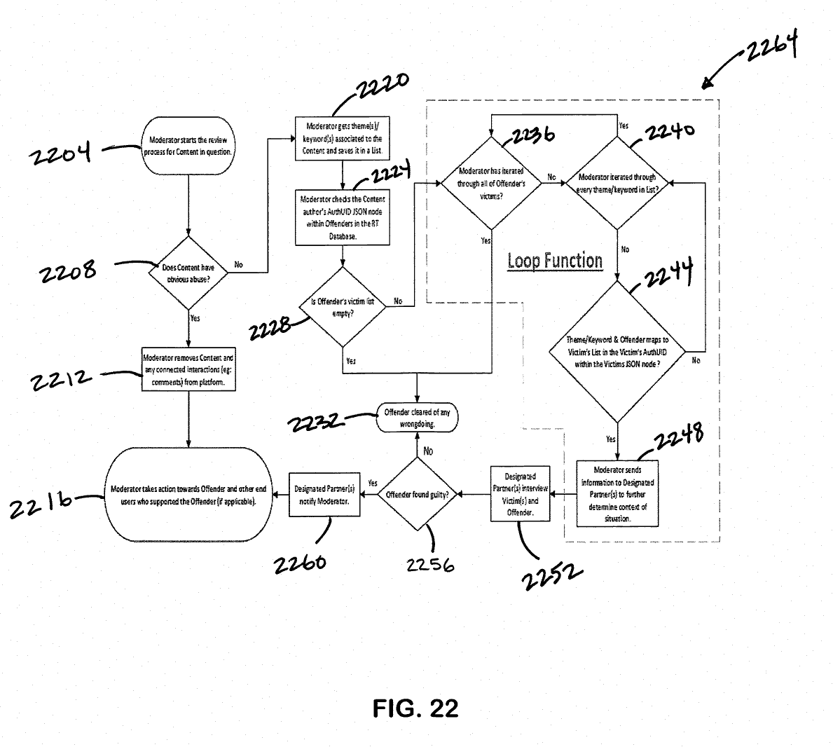

A procedural flow that may be followed by an OCE moderator when called upon to review content or when simply performing an automated maintenance scan will now be described with reference to FIG. 22.

The procedure begins at step 2204 with a moderator initiating a review of the content in question. The ‘content in question’ may be content that has been reported by an end user or may be content selected for review as part of a routine automated review process. If, at step 2208, it is obvious to the moderator that the content is abusive, the moderator removes (per step 2212) the content and any connected interactions (e.g. comments) from the platform. The moderator may then take appropriate action (step 2216).

If at step 2208, the moderator does not find the content to be obviously abusive (i.e. abusive on it's face), the moderator extracts theme(s) and keyword(s) associated with the content and saves it in a list, per step 2220 (techniques for extracting theme(s) and keyword(s) associated with content will be discussed further later on in the disclosure). The moderator, at step 2224 then reads the content author's AuthUID JSON node within the Offenders node in the RT Database (refer to 2120a for example in FIG. 21). Per decision step 2228, if the author's victim list is empty, the offender is cleared of any wrong doing with respect to the content in question (per step 2232). If, on the other hand, the offender's victim list is not empty, loop function 2264 is initiated whereby the theme(s)/keyword(s) associated with the offender's content (which were saved to a list at step 2220) are mapped against each victim-theme/keyword combination found in the offender's victim list, to determine whether there are any matches (steps 2236, 2240, 2244, 2248). If no matches are detected, the loop procedure is exited via step 2236 and the author is cleared of any wrongdoing (step 2232). If, however, a match is detected at step 2244, step 2248 is initiated and the moderator sends information to the partner institution(s) to further determine the context of the content with respect to the affected users. At this stage, the designated partner(s) may interview the potential victim(s) and offender(s) (step 2252) and if it is determined by the designated partner(s) that the offender's content was not abusive (at step 2256), the offender is cleared of any wrongdoing (per step 2232). If, however, the offender is found guilty of abusive content at step 2256, the designated partner notifies the OCE moderator 2260 and the moderator may then take appropriate action (step 2216), if necessary, towards the offending user and/or other end users who supported the offender's content. The designated partner(s) may also choose to take disciplinary action against the offender and other supporting users.

Appropriate action from the OCE moderator may include removing the content and issuing a “last strike” warning to the offender. The moderator may also take action by disabling/removing/banning the offender from the OCE. Where other end users are found to have supported abusive content, the moderator may also decide to take similar action toward those supporting end users. Additionally, where the content was obviously abusive, the moderator may also notify any designated partners associated with the Offender and other supporting end users. The designated partner(s) may then decide to take independent and further disciplinary action. Where the content was abusive but in a non-obvious way, it would not be necessary for the moderator to advise the designated partner(s) as the partner(s) would have already been involved in the determination with respect to the content.

Since the OCE platform utilizes a strict registration process described earlier in this disclosure, offending users that have been banned from the OCE would be highly unlikely to rejoin the OCE, and thus would be effectively prevented from ever poisoning the OCE with abusive content again.

Returning for a moment to the loop function 2264 of FIG. 22, the following associated pseudocode is provided for added clarity:

```
/*******START OF PSEUDOCODE
for (each Victim of the Offender within the Offenders → BullyX
AuthUID JSON node) {
  for (each theme/keyword in the List obtained by the Tickments
  Moderator) {
    Go and get the Victims → VictimY AuthUID → BullyX
AuthUID → theme/keyword JSON node
    if (theme/keyword JSON node exists) {
      Offender is potentially guilty of bullying this specific Victim
      Potential Victim is identified
    }
  }
}
for (each potential Victim identified in the for loop above) {
  Tickments Moderator notifies Partner(s) associated to Offender and
  Victim(s) of a possible bullying incident
}
END OF PSEUDOCODE*******/
```

It is to be appreciated that the theme(s)/keyword(s) obtained by the OCE moderator during the review of the content (at step 2220) may not need to exactly match a victim's theme(s)/keyword(s) in the RT Database during the loop function check 2264. Looking back to the “browny” bullying incident example, a bully may instead create a Tick that references “the color of feces”. In this case, it would be relatively obvious that the author is implying the word “browny” to target his or her victim. The OCE moderator must be smart enough to deduce this. A human moderator can distinguish this. AI utilized by a non-human moderator must also be able to distinguish this.

For the process in FIG. 22 where the OCE moderator gets the theme(s)/keyword(s) associated to the content (step 2220), it is implied that access to content files such as videos, images, etc. . . . stored in Cloud Storage must be accessible for the moderator in order to properly review the content in question. As previously mentioned, files stored in Cloud Storage will have a name matching to the TickID that they are associated to. For example, if an end user has created a Tick with a picture that resulted to a TickID of ABCXYZ being written to the RT Database, then the picture image will be saved in Cloud Storage as “ABCXYZ.jpg”. The moderator will be required to navigate to the proper location within Cloud Storage to obtain the content files needed to review the content.

Techniques and tools that the moderator may use at step 2220 to extract theme(s) and keyword(s) from content being reviewed will now be discussed. In the basic scenario where the content in question contains only text, the moderator may simply read the text from the RT Database to determine associated theme(s) and keyword(s). Where the content consists of merely an image, the moderator may use a Content ID (e.g. a Tick ID, Comment ID, etc. . . . ) associated to the image to access the content's image stored in Cloud Storage and then send the image to the Google Cloud Vision API, an AI service that extracts words, labels and other properties from the image. Google Cloud Vision API will send back the extracted text from the image to the moderator and the extracted text is saved to a list.

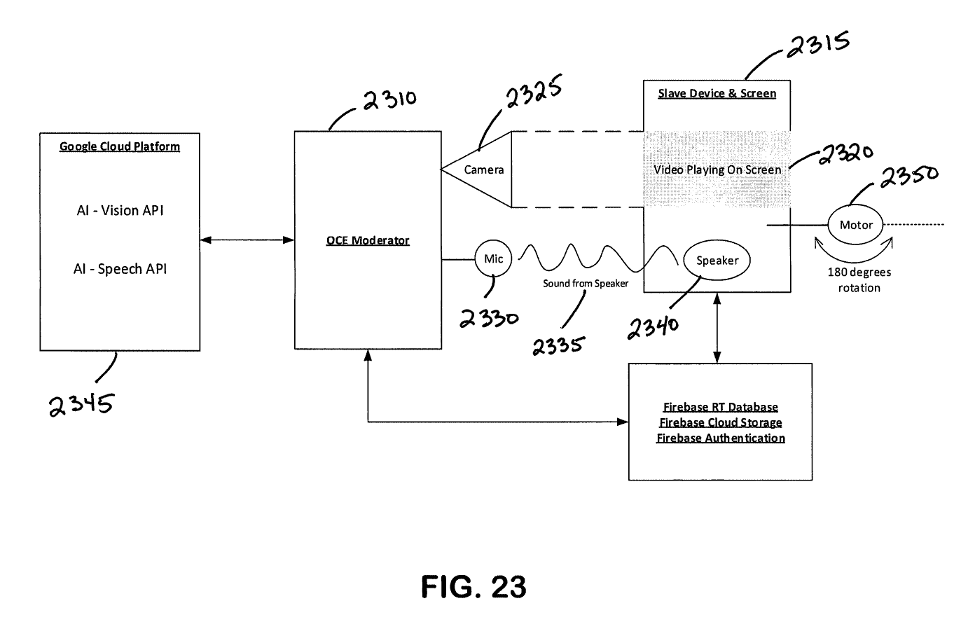

With reference to FIG. 23, in the case where the content in question contains only video, the moderator 2310 may use a slave device 2315 such as a separate Android tablet for example to play the video on the slave device's screen 2320. The OCE moderator uses its camera 2325 and microphone 2330 on its system to capture the sound 2335 and images coming from the slave device's screen 2320 and speakers 2340. The slave device 2315 will be running a slave app to play the video on its screen.

For the sound portion, for example, the moderator may call the Google Cloud Speech API (part of Google Cloud Platform 2345), an AI service that extracts the words spoken in the video to text in real time. Google Cloud Speech API sends back the extracted text in real time to the moderator. For the video image portion, the moderator may periodically pause the video being played on the slave device's screen and take a picture of it with its camera 2325. While the video is paused, the moderator may send the picture taken to the Google Cloud Vision API to extract words, labels and other properties (as described previously).

A mechanical instrument 2350 may be required to ensure that the screen of the slave device is not caused to be turned off. An example of such a mechanical instrument could be a motor coupled to a simulated human skin member, whereby the motor operates to cause the simulated human skin member to periodically “tap” the slave device screen. Alternatively, a “screen sleep setting” may be altered to ensure that the screen is not caused to be turned off in the absence of human interaction. Not shown in the illustration of FIG. 23 is a power source connected to the slave device to ensure that it stays on indefinitely.

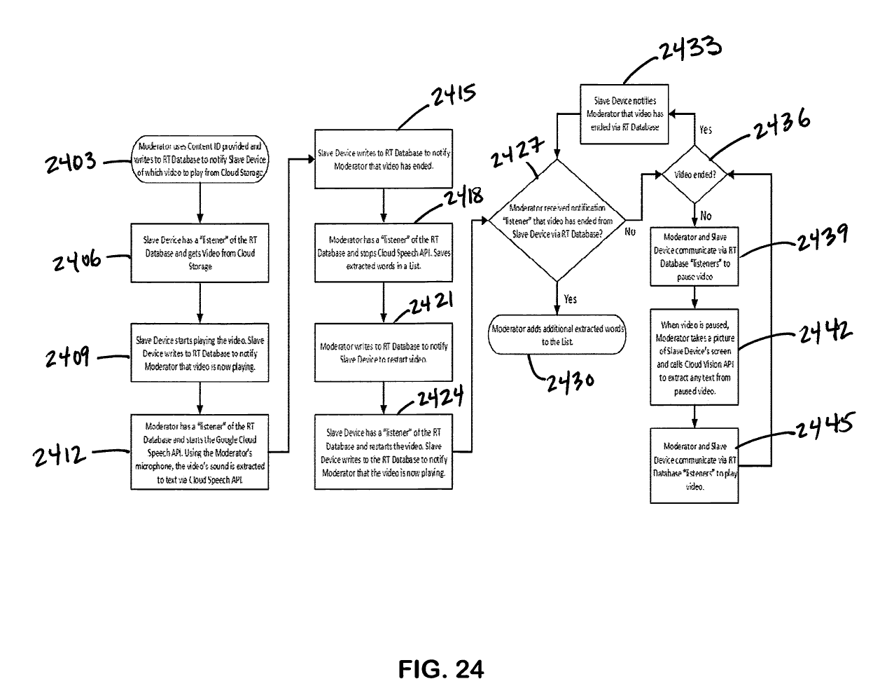

With reference to FIG. 24, an example procedural flowchart with steps to implement the technique described above for extracting theme(s) and keyword(s) from content containing only video will now be discussed. It is assumed in the flowchart that the moderator and slave device are already authenticated to Firebase. Note that the flowchart of FIG. 24 is a possible expansion of step 2220 of FIG. 22.

At step 2403, the OCE moderator uses Content ID provided and writes to RT Database to notify a slave device of which video to play from Cloud Storage. Using a ‘listener’ associated with the RT Database, the slave device receives notification of the video to be retrieved and, at step 2406, retrieves the video from Cloud Storage. At step 2409, slave device starts playing the video and writes to RT Database to notify the OCE moderator that the video is now playing. Through use of a similar RT Database ‘listener’, the moderator is notified that the video is started and, at step 2412, the moderator uses the microphone of its system and Cloud Speech API to extract text from the sound from the video. At step 2415, once the video has finished playing, the slave device writes to RT Database to notify the moderator that the video has ended. Having been notified, again via an RT Database ‘listener’ for example, that the video has ended, the moderator stops Cloud Speech API and saves the extracted words in a list (step 2418). At step 2421 the moderator writes to RT Database to notify the slave device to restart the video. Having received said notification, at step 2424, the slave device restarts the video and writes to RT Database to notify moderator that the video is now playing. From this point, the moderator and slave device communicate, for example via RT Database ‘listeners’, to cause the video to be paused on the slave device 2439 to allow the moderator to take a picture of the slave device's screen and call on Cloud Vision API to extract any words, labels or other properties from the obtained picture 2442, and then cause the video to resume playing 2445. These steps may be performed in a loop until the video has ended 2436 and the moderator has been so notified by the slave device 2433. Once the moderator receives notice from the slave device that the video has ended, decision step 2427 leads to step 2430 whereby the moderator adds the additional extracted words provided by Cloud Vision API to the list.

Another methodology for extracting themes and keywords from a content's video involves the moderator saving a copy of the video in question to Cloud Storage in a different format. For example, end users may upload .mp4 video files to Cloud Storage for the content that they create. The OCE moderator may take this .mp4 video file and create a different copy in Cloud Storage as an audio FLAC file. With the audio FLAC file, the moderator can call the Google Cloud Speech API to extract words directly from the audio FLAC file.

With the .mp4 video file, the moderator can use another video AI service to extract words, labels and other properties from the video, which can then be combined with the extracted words from the audio FLAC file to generate the overall themes and keywords for the content's video.

In the case where the content in question has both text and video. Techniques described above may be appropriately combined to create the list of themes and keywords.

In the context detection system described herein, there is some potential for user abuse. For example, an end user claiming to be bullied by another end user may add endless keywords to the JSON node associated with the alleged offender, thereby triggering the automated OCE moderator to constantly flag the alleged offender. Potential problems associated with this type of abuse include end users experiencing a poor user experience due to their content constantly being improperly flagged for review; and partner being overwhelmed with a large backlog of meritless reports to review.

To combat this potential problem, the ability to write data to the Offenders and Victims JSON nodes (see 2110 and 2140 of FIG. 21) may be restricted to designated partners only. In this case, end users who are truly being bullied would be required to talk to their designated partner administrator/representative to add certain bully's AuthUlDs to the appropriate JSON nodes along with any theme(s)/keyword(s). Alternatively or in conjunction, victim users' requests (via the OCE app or platform) to write to the Offenders and Victims JSON nodes may require pre-approval from their designated partner.

In the example described above, steps are taken when an end user reports potentially abusive content, or potentially requested a Private User's content to be reviewed because they may suspect that they are being victimized by the Private User but are unsure, or when the OCE administrator or moderator runs a maintenance check. These are all examples of post-share review. It is also possible to implement the context detection system such that the review is performed pre-share (i.e. prior to the content in question being saved to the RT Database and if applicable, to Cloud Storage).

For example, where an offender wants to bully one of his victims and there exists a Victim-Offender relationship in the RT Database, if the offender creates content that contains theme(s)/keyword(s) that one of their victims is sensitive to, the offender may be prompted with a warning message advising to change their content to something more respectful. In this way, the offensive content will be avoided at the outset and will never be saved to the RT Database and if applicable, Cloud Storage.

Literature suggests that the use of social media and technology may have associated negative side effects to children's mental health well being. For example, overuse of technology can lead to technological addiction which in turn may lead to under-developed social skills. Technological addiction may also lead to adverse physical side effects to children given that time spent on technological devices typically detracts from the performance of physical activity. According to some reports, children are spending about an average 9 hours per day using technology (see for example CNN article: http://www.cnn.com/2015/11/03/health/teens-tweens-media-screen-use-report/index.html).

Another notable point with regards to overuse of technology is that technology-facilitated communication typically tends to happen with weaker social ties such as acquaintances and strangers as opposed to stronger social ties such as family, classmates, other friends, etc. . . . . Some social support literature suggests that interaction with strong ties (versus weak ties) is more likely to promote well-being (see for example the article available at: http://onlinelibrary.wiley.com/doi/10.1111/jcc4.12162/pdf).

To summarize, three problems known to be associated with use of technology and social media platforms include: 1) potential to become addicted to technological devices and social media; 2) lack of real world interactions necessary for the development of face-to-face social skills; and, 3) communicating with weaker ties leading to decreased mental health. Solutions to these problems are described below including 1) encouraging users to have “real world” interactions with friends; 2) providing additional rewards and coupons to users who participate in “real world” interactions with their friends; and, 3) providing an easily accessible visual indicator to indicate to a user their relative level of interaction with strong social ties.

The following are exemplary embodiments demonstrating how the OCE platform may encourage users to interact with each other in the “real world”. Users may be encouraged to participate in the OCE only moderately in order to have true face-to-face interactions with other people, which will promote the development of social skills. Some of the following embodiments will require a wearable technology such as for example the Polar H7 Heart Rate Monitor to be integrated with the OCE app or platform (i.e. the end user may be wearing a Bluetooth Smart Heart Rate Monitor that is paired to their smartphone that has the OCE app installed on it. The Bluetooth Smart Heart Rate Monitor is responsible for transmitting heart rate data to the smartphone, and the technical details of how this is accomplished are generally known to those skilled in the art and therefore not elaborated on in this disclosure.

As will be further discussed, one way in which a user may be encouraged to engage in real world interactions in accordance with this disclosure is to selectively monitor users' usage of their technological device and deny rewards and/or coupons if the user used their device during a certain time period (e.g. checking their phone while out for a run with friends).

The embodiments below are not intended to limit this disclosure but rather are provided for demonstrative purposes. Users of the OCE app or platform may also be encouraged to have real world interactions in ways that are not described in this disclosure.

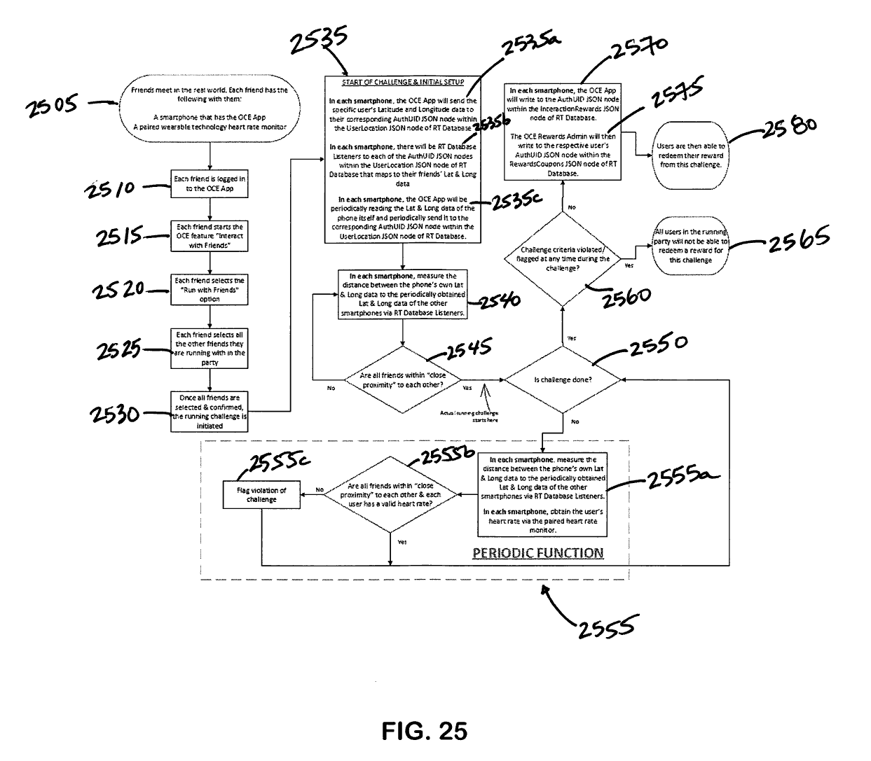

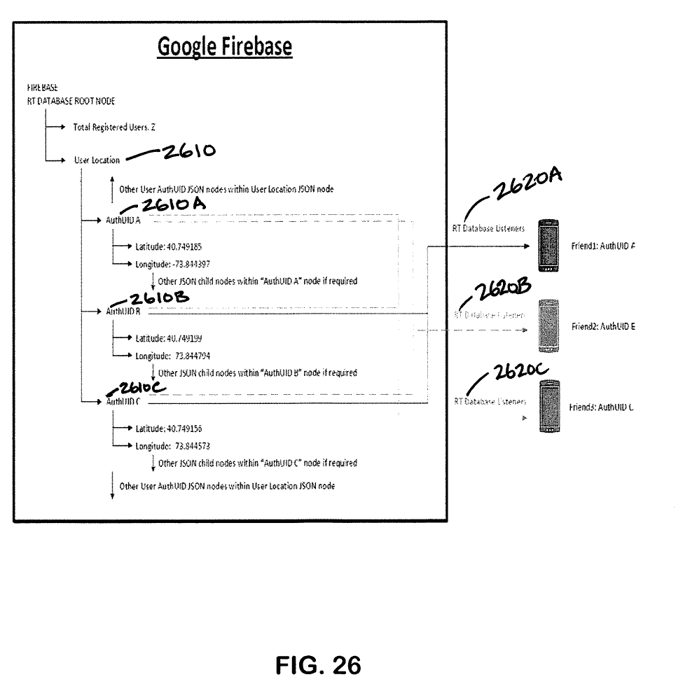

In a first example of encouraging real world interactions, three friends have decided to meet up in person after school to go for a run together. The friends may select a challenge within the OCE that requires them to run together to achieve a distance-based goal, or alternatively a time-based goal. A criteria of the challenge may be that the friends must be within close proximity of each other for the entire duration of the run. For example, throughout the entire run, the friends must remain within 15 meters of each other. This example will be further discussed with reference to FIGS. 25 to 27.

At step 2505, the three friends meet in the real world and each friend has a smartphone with the OCE app installed on it, and a paired wearable technology heart rate monitor.

Each friend is logged in to the OCE app 2510; each friend selects the OCE “Interact with Friends” feature 2515 and then the “Run with Friends” option 2520. Each friend then selects/identifies all the other friends they are running with in the party/group 2525. The running challenge is then initiated 2530. Note the flowchart illustrates a challenge that is time-based.

An initial setup process is then initiated at 2535 whereby the following occurs at each of the friends' smartphones: i) the OCE app will send the specific user's latitude and longitude data to their corresponding AuthUID JSON node (2610A, 2610B or 2610C) within the User Location JSON node (2610) of the RT Database 2535a; ii) RT Database listeners (2620A, 2620B, 2620C) will be set to each of the AuthUID JSON nodes within the User Location JSON node of RT Database that maps to their friends' latitude and longitude data 2535b; and, iii) the OCE app will be periodically reading the latitude and longitude data of the phone itself and periodically sending the data to the corresponding AuthUID JSON node within the User Location JSON node of the RT Database 2535c. This will allow the RT Database listeners in the other smartphones to be properly synced to the phone in question. At step 2540, for each smartphone, the distance between the phone's own latitude and longitude data and the periodically obtained latitude and longitude data of the other smart phones is measured so that it may be determined (at step 2545) if the friends are within the required proximity of each other. If they are, the running challenge begins and the process moves to step 2550, where it is determined whether the challenge is done by comparing the time elapsed since the challenge began to the time-goal established by the challenge. As long as the challenge is not finished, the process performs the periodic function 2555 whereby it is determined whether the users have remained within the challenge-required distance (with respect to one another) throughout the duration of the run 2555a and whether each user is registering a valid heart rate 2555b. In a running challenge, for example, it is expected that the users' heart rate elevated to a certain level throughout. A lower heart rate may signal that the user has somehow cheated the challenge by, for example, riding in a vehicle instead of running. From step 2555b, either the users are found to have met the criteria and the periodic function is restarted, or it is determined that the users were too far apart or a user is found to have a suspicious heart rate and a violation is flagged at step 2555c prior to restarting the periodic function.

Once it is determined at step 2550 that the challenge is over, a check is performed to see whether a challenge violated flag was produced at any point throughout the challenge (step 2560). If a flag is found to have been produced, the process ends with none of the users having earned a reward for the challenge 2565. Conversely, if it is determined (at step 2560) that no flag was produced, then in each smartphone, the OCE app will write to the AuthUID JSON node (2720A, 2720B, 2720C) within the InteractionsRewards JSON node (2710) of RT Database 2570 and the OCE rewards administrator, via an appropriate listener, is notified and writes to the respective user's AuthUID JSON node (2740A, 2740B, 2740C) within the RewardsCoupons JSON node (2730) of RT Database 2575. Finally, the users are then able to redeem their reward from the challenge 2580.

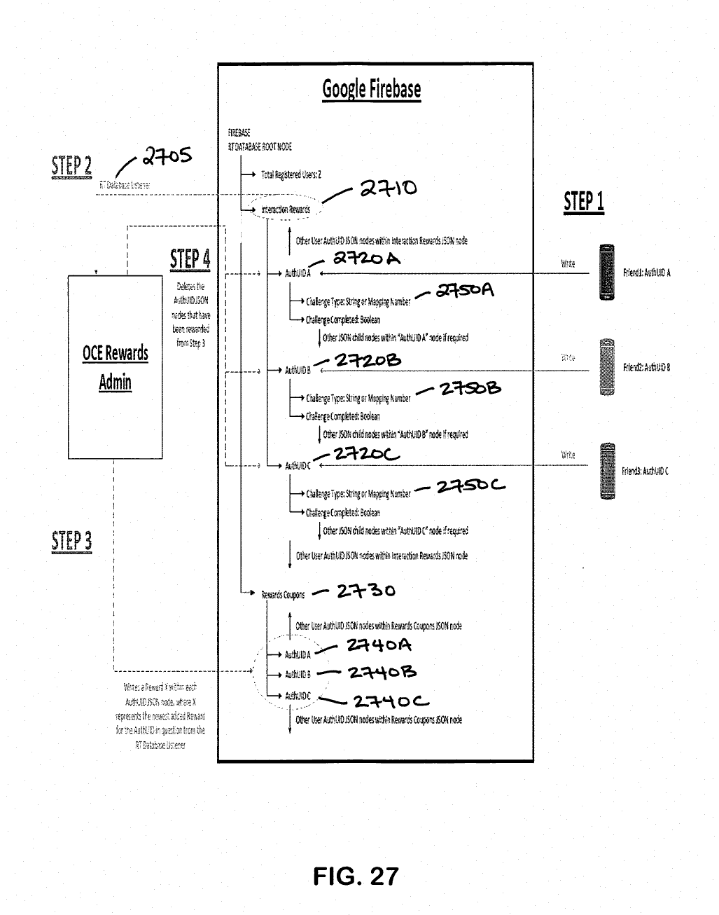

With continuing reference to FIGS. 25 and 27, when end users complete a challenge successfully, the following steps are taken to ensure that the end users are rewarded:

Step 1: Each friend will write to their respective AuthUID JSON node within the InteractionRewards JSON node of RT Database.

Step 2: The OCE rewards administrator has an RT Database listener 2705 attached to the InteractionRewards JSON node 2710 of RT Database. With this RT Database listener, the OCE rewards administrator will be immediately notified when end users have successfully completed a challenge.

Step 3: The OCE rewards administrator writes a reward to the respective AuthUID JSON nodes 2740A, 2740B, 2740C within the RewardsCoupons JSON node 2730 of RT Database. Details about writing to each AuthUID JSON node has already been previously discussed with reference to FIG. 18 and will not be repeated here.

Step 4: The OCE rewards administrator deletes the AuthUID JSON nodes 2720A, 2720B, 2720C (that have been rewarded in Step 3) from the InteractionRewards JSON node 2710 of RT Database.

Preferably with Step 2, the programmer responsible for writing the code for the OCE rewards administrator must ensure that when the RT Database listener is triggered, new additions/removals to the InteractionRewards JSON node will not be processed by the OCE rewards administrator until the full completion of Step 4. The OCE rewards administrator will read the entire InteractionRewards JSON node again once Step 4 is fully complete and that there are new additions added to the InteractionRewards JSON node from challenges completed by end users.

Also note from FIG. 27, the “Challenge Type” node 2750A, 2750B, 2750C represents the type of challenge that the end user has participated in and may be in the following format:

| | Type | |
|---|---|---|
| | | Challenge Type - Mapping |
| | Challenge Type - String | Number |
| Run Alone | “Run Alone” | 0 |
| Run With Friends | “Run With Friends” | 1 |
| Play Soccer With | “Soccer With Friends” | 2 |
| Friends | | |
| Play Tennis With | “Tennis With Friends” | 3 |
| Friends | | |
| Etc . . . | Etc . . . | Etc . . . |

As indicated in the above table, another type of challenge may be playing a sport, such as for example soccer, tennis, basketball, etc . . . , with one or more friends. The logic to be followed for this type of challenge is similar to that described for the running with friends example above, except that in this type of challenge, the smartphones would be stationary in the middle sideline of the soccer field/tennis court/basketball court and etc. The smartphones will have a latitude and longitude data tracked and used to check if friends within the group are actually hanging out close to each other in the real world.

Again, heart rate monitors paired to each smartphone will ensure that the users/friends are actually participating in the challenge. There may be times where a friend may take a break and this will cause their heart rate reading to drop. Therefore, for these types of challenges, the criteria may be: i) are the smartphones on the sideline within close proximity to each other the entire challenge; and do the heart rate readings have periods of higher measurements indicating participation?

With regards to criteria ii, an injured friend who wants to hang out with the friends participating in the challenge may also be eligible to earn rewards and coupons as long as this injured friend's smartphone latitude and longitude data is within close proximity to the other smartphones.

Existing wearable technology have a relatively long range, therefore even if the participants in a soccer field are far from their smartphones, heart rate measurements would still be obtainable.

Other example challenges could include going to a friend's house, going shopping with friends, hanging out with friends, for example, at a park. In these examples, paired wearable technology may not be required. The latitude and longitude data of the smartphones may simply be monitored to check if the friends are within close proximity to each other throughout the entire challenge.

As previously described, one potential drawback of OCEs is the potential for users to connect and interact with “weaker ties” more often so than they do with their “stronger ties”. Interacting with weaker ties is ok, but a person who engaged with weaker ties more often than stronger ties may be more likely to experience negative mental health effects because relationships with weaker ties are not as fulfilling/satisfying. From a mental health perspective, it is best for people to spend more time interacting and engaging with their stronger ties in an effort to stave off depression.

To that effect, a depression detection system is described below to help end users, designated partners, and others to see the early signs of depression and to allow the end users to seek helpful resources earlier. These days, depression is often quite at a late stage as people tend to experience depression prior to seeking professional help, from a psychiatrist for example. Details of a depression detection system provided below are provided for exemplary purposes and are not intended to limit the system to a single implementation. The depression detection system may either be implemented within the OCE app or platform and/or within the internal systems of Tickments Inc.

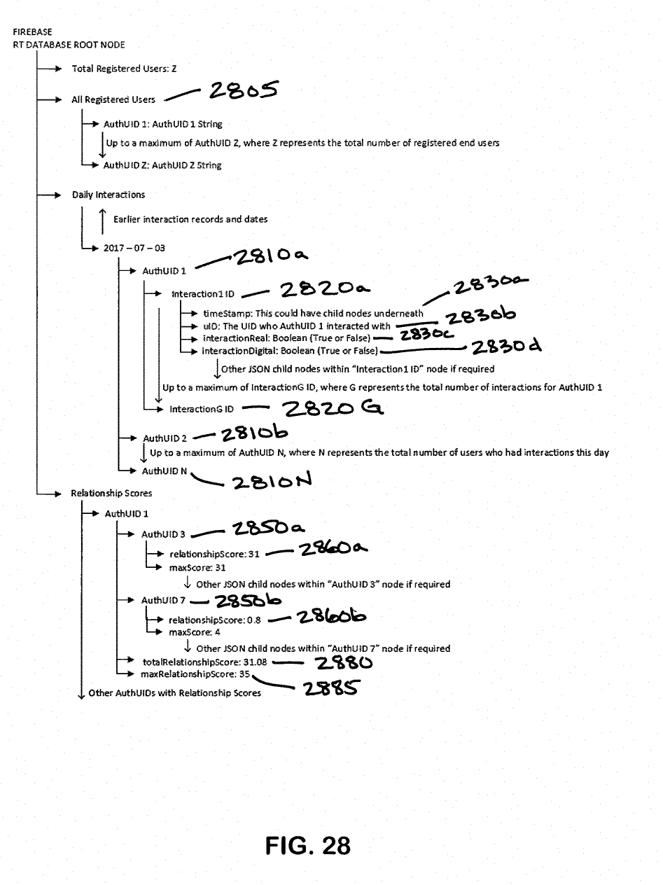

With reference to the simplified JSON structure depicted in FIG. 28, the following outlines how a depression detection system may operate and be implemented, beginning with an end user (let's refer to this end user as AuthUID1) that has successfully signed up and logged in to the OCE app or platform for the very first time. For each other end user that this end user follows, a Relationship Scores JSON node (e.g. 2850a or 2850b) is written and a relationshipScore (e.g. 2860a or 2860b) is established between them and maintained. For the sake of this example, consider two other end users that AuthUID1 follows within the OCE. These other two end users will be referred to as AuthUID3 and AuthUID7 (consistent with the structure of FIG. 28). If AuthUID1 follows AuthUID3, a relationshipScore 2860a between these two end users is written. Although this value is shown with a value of 31 in FIG. 28, this value would initially be set to 0 (prior to any interactions occurring between these users. Similarly, when AuthUID1 follows AuthUID 7, a relationshipScore 2860b between these two end users is written.

A totalRelationshipScore (e.g. 2880) is also maintained for each end user and is calculated by adding all of the individual relationshipScores (e.g. 2860a,2860b) created between them and those end users that they are following. In our example, at any given moment, totalRelationshipScore for AuthUID1 will be equal to the sum of the relationshipScore between him/her and AuthUID3 2860a and him/her and AuthUID7 2860b.

The relationship score value between two users may be affected by both real world interactions (such as any of the real world interaction examples described earlier in this disclosure) and digital interactions within the OCE (such as mentioning another user in a Tick, commenting to a Tick, giving likes/cheers and etc. . . . ). In order to encourage real world interactions over digital interactions, real world interactions may affect the relationship score value more significantly than digital interactions. For example, a real world interaction between AuthUID1 and AuthUID3 may increment relationshipScore 1-3 2860a by an amount “X” and a digital interaction between the same users would increment their relationship score by an amount “Y” where “X” is greater than “Y”. As a non-limiting example, X may be set to 1, whereas Y may be set to 0.1. In this example, a real world interaction (such as running with a friend) would therefore increase the relationship score by 10 times the amount of a digital interaction (such as commenting on a Tick). As this example demonstrates, by appropriately selecting the values for X and Y, users may be encouraged to use the OCE app or platform moderately relative to engaging with others in the real world.

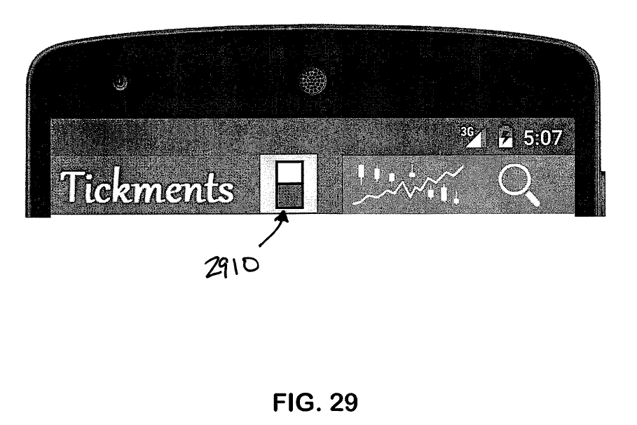

Continuing with our example, when AuthUID1 starts to interact with the other users they follow either in the real world or digitally, their total relationship score will start to increase. Relationship scores and total relationship scores are not capped and can therefore increase as long as an end user keeps interacting with other end users. The depression detection system may be programmed to begin only once this end user's total relationship score has reached a threshold level, which will be referred to as “Z”. At this time, a visual indicator, such as a total relationship score meter (see for example 2910 of FIG. 29) may appear to the end user when interacting with the OCE user interface.

Similarly to X and Y, the value for Z should be chosen and set in such a way that users are encouraged to use technology and social media moderately and to engage more with others in the real world. As will be appreciated by the reader, the depression detection system will not be initially enabled for end users because they need to build up their total relationship score to threshold level Z first.

Each relationship score between two end users may also be decremented at the end of a given day by predetermined amount, which will be referred to as DECR, when the end users have not interacted/engaged with each other throughout the course of the day in question. The value for DECR may be set, for example, to Y so that a digital interaction from the previous day is essentially subtracted from the relationship score and total relationship score today. In this example, because the points earned for real world interactions are greater than those earned for digital interactions, the effects on a real world interaction are less impacted by daily DECR decrement.

Essentially, DECR may be thought of as acting like gravity to keep the end users in check as to how often they interact/engage with others.

It may be desirable to modify the values forX, Y, Z, and DECR to take into account different levels of introversion between users. For instance, introverted people will typically have less interactions as compared to extroverted people. To accommodate this, there may be a feature within the OCE app or platform that a user can use to communicate their level of introversion (for example, the user may have the option to take a personality test such as the Myers Briggs within the app or platform). A user's level of introversion may also be obtained based on how often a user engages with other users within the OCE.

For each end user having a total relationship score, a maxRelationshipScore (e.g. 2885) that equals the highest total relationship score they have ever achieved will also be tracked and recorded. If the totalRelationshipScore for a given user falls below the user's maxRelationshipScore by a predetermined amount (this predetermined value will be referred to as WARNG for this example and may be either a points amount or a percentage), and the depression detection system has already been enabled, then the depression detection system may enable an alert to the end user to spend more time, interact, and/or engage with their stronger ties. The alert message from the OCE app or platform may be accompanied by an optional response feature such as a fillable text field or radio button selections that the end user can use to notify the OCE master administrator as to the reasons for the decline of their total relationship score.

In addition to communicating an alert message, the depression detection system can check and/or monitor the end user's average tick values for a period of time prior to and/or after the decline. That period of time may for example be 2 weeks or any other period deemed appropriate. If during the given time period before and/or after the decline in total relationship score, the average tick value is less than a predetermined value, for example 5, the depression detection system may notify the designated partner and alert them to check up on the end user.

If the average tick value is equal to or greater than the predetermined value (of 5 in this example) for the given time period before and/or after the decline, it may be that the end user is happy and simply introverted by nature. It may be that the end user is simply using the OCE app or platform as a social personal diary that any other end user can view. This scenario may not suggest declining mental health but may nonetheless be reported to the designated partner for follow up with the end user.

Additional rewards and coupons may be offered to an end user, in a similar fashion as described above, for getting their total relationship score back to increasing and/or for exceeding their previous max relationship score. Preferably the rewards and coupons would entice the end user to change something about their life to get them back on track to positive mental health.

Where an end user is found to be abusing the system by for example faking a mental health issue and causing their average tick value to drop below 5 (or whatever the predetermined value has been set to) and their total relationship score to decline by WARNG below their max relationship score, the designated partner and/or the OCE master administrator may take the necessary actions to prevent further abuse. For example, the end user may be banned from the platform.

Given that real world interactions tend to be with stronger ties rather than weaker ties, it is expected that the total relationship score for an end user will be weighted heavily from their strong/close ties. The steps above ensure that end users spend more of their time interacting and engaging with their closer ties in the real world.

Returning to the concepts of totalRelationshipScore and maxRelationshipScore for a moment, because these values depend on which end users a given end user is following at that time, the values will need to be changed in the event a user-to-user following relationship is terminated. For example, if AuthUID1 unfollows AuthUID7, the values of relationshipScore 1-7 2860b and maxScore 1-7 2860b will need to be subtracted from the totalRelationshipScore 2880 and maxRelationshipScore 2885, respectively, for AuthUID1. In the example of FIG. 28, if AuthUID1 unfollows AuthUID7, then the new totalRelationshipScore and maxRelationshipScore for AuthUID1 will change from 31.08 and 35 to 31 and 31, respectively.

An OCE score administrator, which may for example be a computer, may be responsible for administrating the relationship scoring system. After an interaction has occurred and is complete, the OCE app or platform being used by the end user will write a new Interaction ID JSON node (e.g. 2820a). Each Interaction ID written must be unique from one another.

For example, at the end of the UTC day of 2017 July 2003 (8:00 pm Eastern Standard Time), the OCE score administrator will obtain all users within the All Registered Users JSON node 2805. Note that the date at this point in terms of UTC time will be 2017-July 2004 (0:00 am UTC).

At this point, the following pseudocode will govern the OCE score administrator. A “global” list of sorts will be required to save data for the various interactions, which we will call InteractionsList. Initially this list will be empty and clear. Also, a “global” Boolean variable of sorts will be required to determine if there were any increments done. Let's call this Boolean variable IncrementTF, initially set to false.

```
//START OF PSEUDOCODE FOR DEPRESSION DETECTION SYSTEM - OCE
SCORE ADMINISTRATOR
For (each user within the All Registered Users JSON node) {
  Obtain the AuthUID of the user in question for this iteration of the for loop.
  AuthUID InteractionData JSON node = RT Database Root Node → Daily Interactions
→
  Previous UTC Date (being 2017 - 07 - 03) → AuthUID obtained
  For (each interaction within the AuthUID InteractionData JSON node) {
    Save the specific interaction data in question for this iteration of the for loop into the
InteractionsList.
    Each element in the InteractionsList will contain information such as timestamp, uID,
interactionReal,
    interactionDigital, and etc. For example, what is being saved into a single
spot/element in the
    InteractionsList are the child nodes below Interaction1 ID on Figure 28.
  }
  AuthUID RelationshipScoreData JSON node = RT Database Root Node → Relationship
Scores →
  AuthUID obtained
  For (each relationship within the AuthUID RelationshipScoreData JSON node) {
    For (each interaction data in the InteractionsList) {
      If (AuthUID relationship in question matches the uID in the InteractionsList spot
in question) {
        Increment the Relationship Score of the AuthUID relationship in question by
either X or Y
        depending on the InteractionsList spot in question's data indicating if the
interaction was in the
        real world or digital.
        Set IncrementTF = true
      }
    }
    If (IncrementTF == false) { //meaning no matches for the AuthUID relationship in
question
      Decrement the Relationship Score of the AuthUID relationship in question by
DECR.
    }
    Set IncrementTF = false
  }
  Clear the InteractionsList.
}
//END OF PSEUDOCODE
```

The pseudocode above assumes that the end user in question has an interaction in the previous day. The case where the end user does not have an interaction from the previous day was left out as it would be convoluted and difficult to follow. The person skilled in the art however, would have the general knowledge required to write the code for that scenario.

The pseudocode for updating the totalRelationshipScore and maxRelationshipScore are similarly not provided in this disclosure. As the skilled person would appreciate, however, it is implied that when the OCE score administrator is updating individual relationship scores, the totalRelationshipScore and maxRelationshipScore will need to be updated accordingly.

With reference to FIG. 29, from a user interface point of view, the visual indicator 2910 for the totalRelationshipScore may look similar to a battery meter (referred to herein as the Total Relationship Score Meter) that can warn the end user when their totalRelationshipScore is dropping and possibly getting close to the WARNG level/percent. When the Total Relationship Score Meter has been completely drained, the depression detection system then alert the end user to spend more time, interact, and/or engage with their stronger ties. This visual indicator may flash periodically, animate, or otherwise be displayed to attract the attention of the end user.

With the Total Relationship Score Meter visible in the UI of the OCE app or platform, end users are provided an independent, objective measure of their mental health based on their engagement with strong ties. This in turn, allows end users that may be unaware that their mental health is suffering to seek professional mental health aide at an early stage.

A fully charged (100%) Total Relationship Score Meter fully charged at 100% may indicate either that the Z level threshold has been reached by an end user who is still building up their totalRelationshipScore from its initial level of 0, or that the totalRelationshipScore is equal to the maxRelationshipScore for the user.

A Total Relationship Score Meter between 0% and 100% may indicate that totalRelationshipScore is less than maxRelationshipScore and totalRelationshipScore is equal to or greater than “maxRelationshipScore minus WARNG”.

A completely depleted Total Relationship Score Meter (at 0%) may mean that totalRelationshipScore is less than “maxRelationshipScore minus WARNG”.

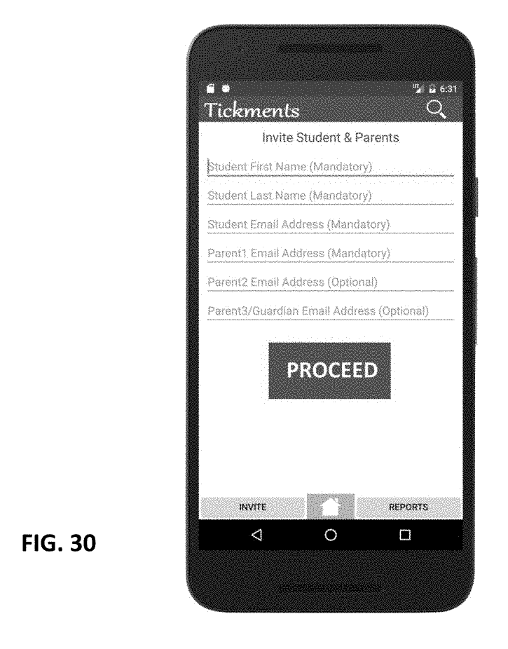

Another embodiment of the present disclosure, in which positive user behaviour is incentivized, will now be described with reference to FIGS. 30 to 34. Positive interactions between users of the OCE platform help to promote stronger mental health among the users. Accordingly, it may be desirable to identify, validate and reward such interactions within the platform. The following exemplary embodiment describes how this positive reinforcement may be accomplished with the assistance of the parents, guardians and/or authorized caretakers of the users of the OCE platform. For simplicity, the following description will refer only to parents, however, it should be understood that guardians or authorized caretakers may also perform a similar function. Also, although parents, guardians and/or caretakers are contemplated in the described embodiment, comment validation may alternatively be achieved with the assistance of artificial intelligence, where for example an OCE “I Feel Encouraged” Administrator analyzes the identified encouraging comments and validates them where appropriate using a context detector such as Google Cloud Platform Natural Language API.

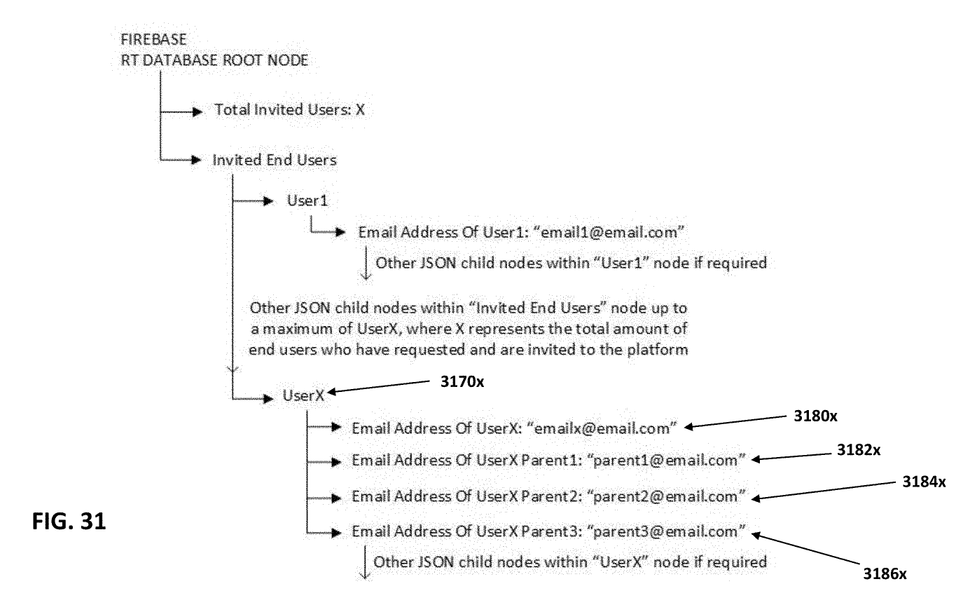

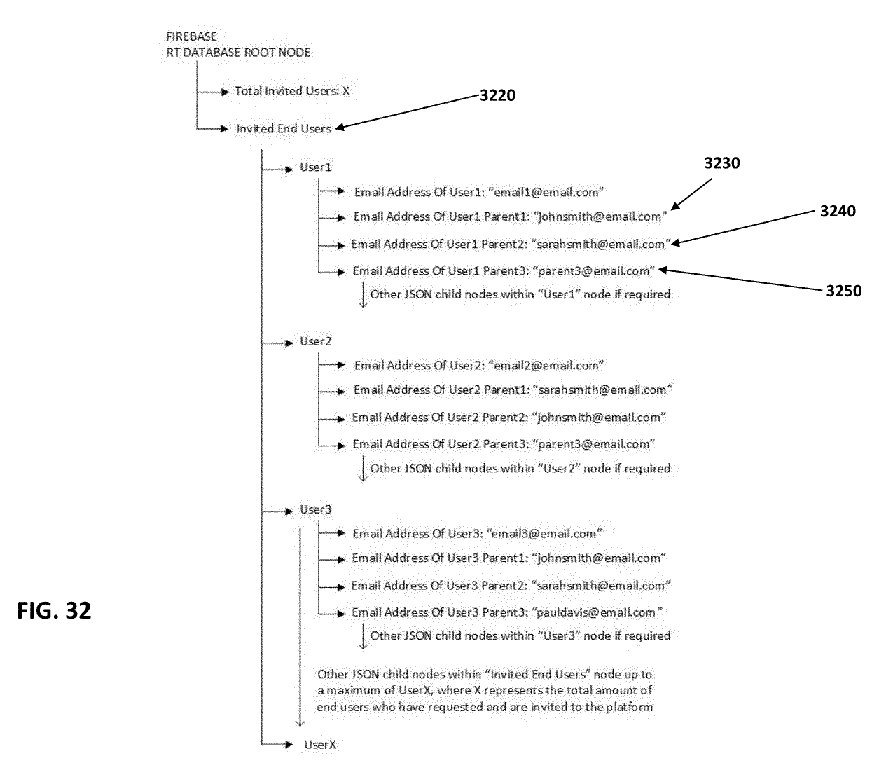

In order to participate in the OCE platform, parents must be invited to the platform. FIG. 30 shows a GUI page of the OCE platform where the parents may be invited to participate by a designated partner entering the parent's identifying information (e.g. email address). The GUI shown in FIG. 30 may be displayed, for example, when a designated partner is completing step 525 of the method from FIG. 5. At this step, the designated partner may input the email address for one or more parents of the requesting end user. FIG. 31, shows a simple representation of a JSON structure that includes the email addresses for multiple parents of a user that have been input by the designated partner at step 525 of the method of FIG. 5. As depicted, for a given JSON child of a given user, e.g. User X 3170x, a child node is written with the email address of each parent 3182x, 3184x, 3186x that was input by the designated partner. More than two parents are permitted to accommodate the modern-day family. Since parents may have multiple children, a parent's email address may appear as a child node in more than one user's JSON structure (as illustrated in FIG. 32).

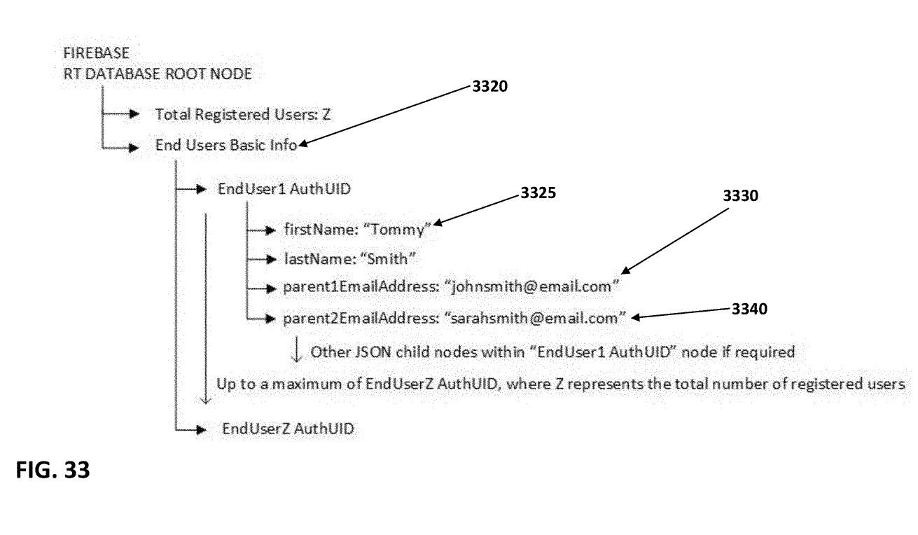

With returning reference to FIG. 4, which outlines the steps for registration by an end user, recall that an end user may complete the registration process in the OCE application (step 460) provided it has been confirmed that their email address is within the “Invited End Users” RT database node. As part of this registration step, a query may be performed whereby the parents' email addresses that were input by the designated partner are written to the End Users Basic Info JSON child nodes. For example, consider an example where User 1 registers for the OCE platform with three parents' email addresses having been input by the designated partner. With reference to FIGS. 32 and 33, when User 1 registers for the OCE platform at step 460 (FIG. 4), a query for the end user's email address within the Invited End Users JSON node 3220 will retrieve the entire User1 JSON node (within Invited End Users JSON node) and its subsequent child nodes such as for example the parent email address child nodes (Parent1 3230, Parent2 3240, Parent3 3250). Then, the email addresses of the parents (e.g. 3330, 3340) are written to the End Users Basic Info JSON node 3320 (the email address for Parent3 from FIG. 32 has been omitted from FIG. 33).

Once a parent has been granted access to the OCE (i.e. their email address was input by a designated partner in association with an end user), they will then be able to complete the registration process by, for example, inputting their email address and identifying information in the OCE App (which may be a separate application to the end user's version, or the same version with a different user interface). The content available to a parent may be different than that available to an end user. For example, whereas an end user may be able to interact with other end users, a parent may be limited to only view the content of their children (or a subset of that content). To achieve this content restriction, each time a parent runs the OCE application, a query may be performed to identify end users whose End Users Basic Info JSON node contains that parent's email address as a child node (e.g. 3330 or 3340). The parent will only be able to see content of those end users identified in the query.

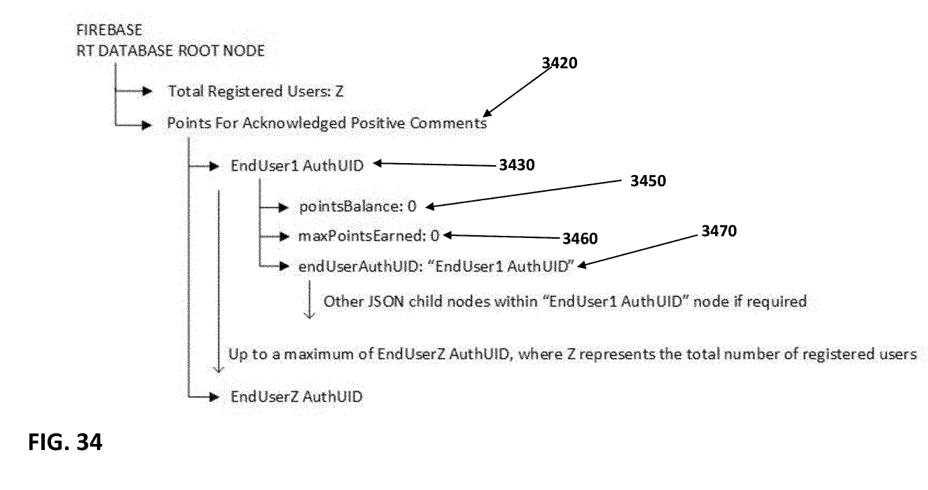

In this embodiment, where positive interactions are incentivized, additional information may be written to the RT database at step 460 of the registration process, for example within a JSON node designated “Points for Acknowledged Positive Comments”. FIG. 34 shows an example of a simplified JSON structure that may be used for this purpose.

Within the JSON node designated “Points for Acknowledged Positive Comments” 3420, there may be a child node for each EndUser AuthUID 3430 (as a result of the write operation from step 460) on record with subsequent child nodes for, for example, pointsBalance 3450, maxPointsEarned 3460, and endUserAuthUID 3470. Other JSON child nodes within “EndUser1 AuthUID may be added if desirable. When the JSON child node for a given end user is first written within the “Points for Acknowledged Positive Comments” JSON, the pointsBalance and maxPointsEarned for an end user will be set to 0 (as shown in FIG. 34). This JSON node will be utilized to monitor and keep track of each registered end user's positive comments points history for purposes that will be described in more detail below.

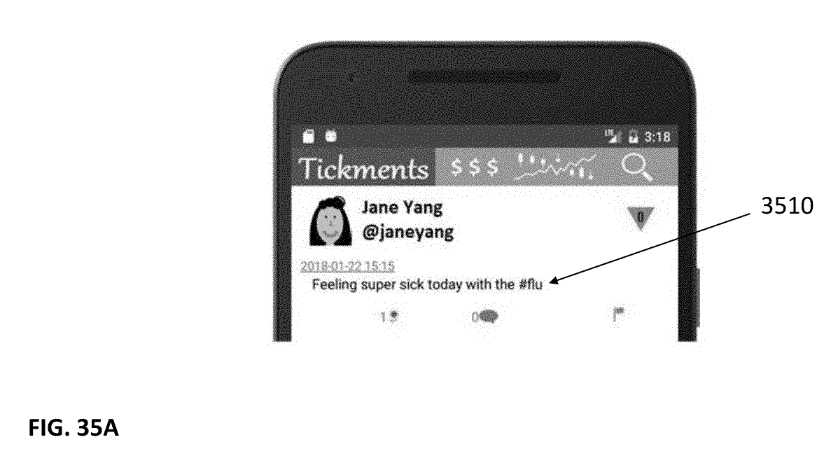

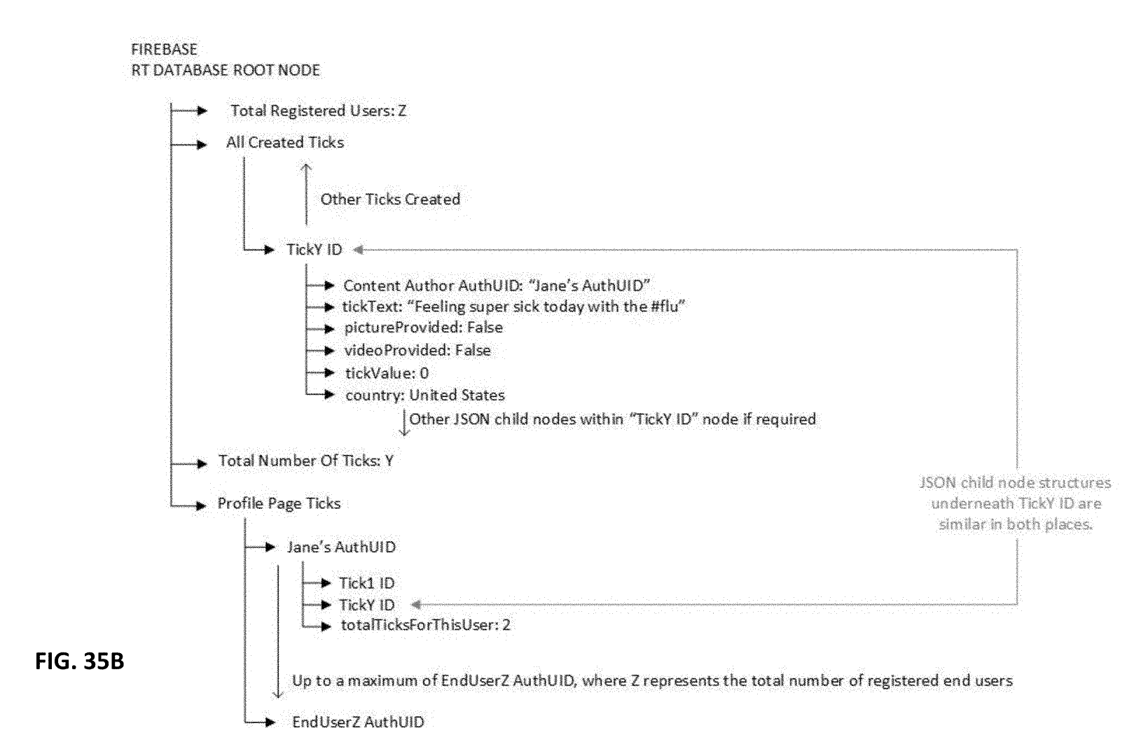

An exemplary process through which an encouraging comment is acknowledged, validated and rewarded will now be described with reference to FIGS. 35 to 39, and an example scenario where an end user named Jane posts a Tick and one of Jane's followers named Tommy comments on that Tick. As described earlier in this disclosure, when Jane creates a Tick, a new unique TickID is created and associated to the Tick (FIG. 7 and the accompanying disclosure shows how a Tick is saved to RT Database within the All Created Ticks and Profile Page Ticks JSON nodes). For the sake of this example, let the TickID for Jane's newly created Tick be TickYID, where Y represents the total number of Ticks ever created worldwide. Jane's Tick in this example is therefore the most recently created Tick among all end users. FIG. 35A shows an exemplary user interface for displaying Jane's Tick contents 3510 within the OCE application. FIG. 35B shows a simplified JSON structure of the All Created Ticks and Profile Page Ticks JSON nodes.

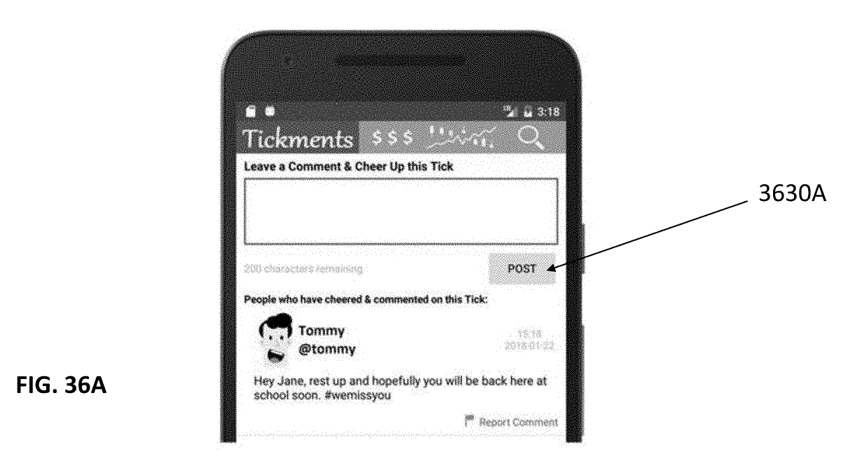

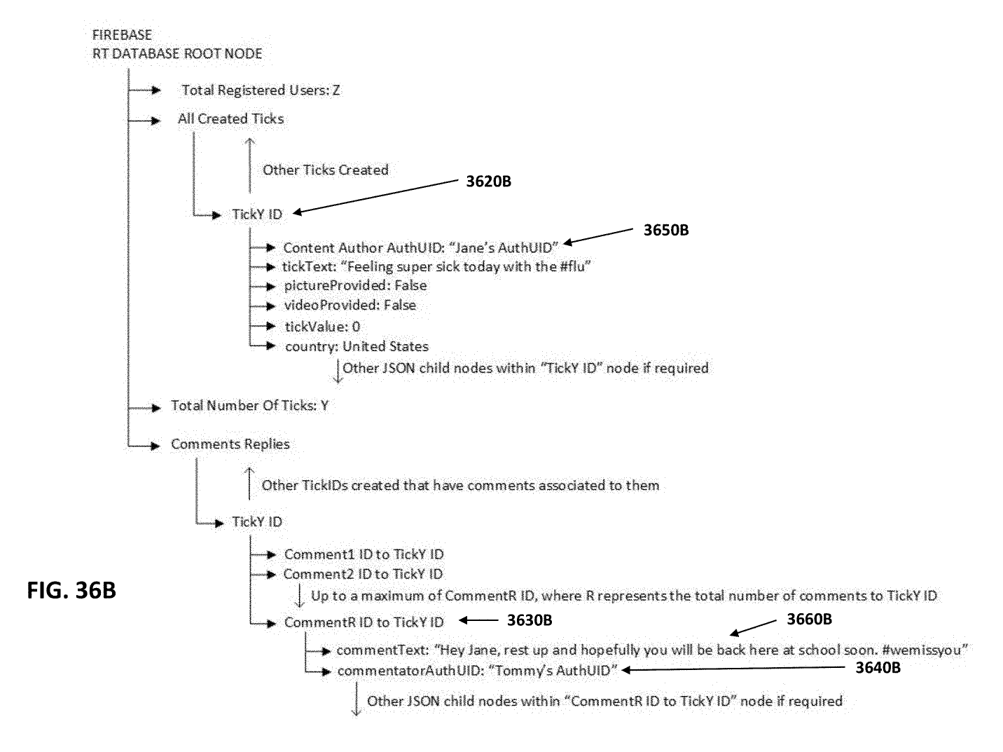

When Tommy sees Jane's Tick from his Home Feed page (refer to FIG. 10 for an exemplary Home Feed page), he has the option of clicking on the chat bubble icon (e.g. 1050 of FIG. 10). Clicking on the chat bubble icon will cause a Comments Page where Jane and other users (including Tommy) can view and scroll through other comments left in response to Jane's Tick. Also, from the Comments Page, Tommy has the option to write a comment to Jane's Tick and share it by clicking, for example, a post button (similar to 3630A in FIG. 36A).

Comments to Ticks are associated to the Tick in question within RT Database. For example, when a comment is created, a CommentID is generated which is uniquely and specifically associated to a unique TickID. FIG. 36A shows an exemplary user interface for displaying the Comments Page within the OCE application for a Tick not authored by the end user viewing the Comments Page (i.e. those other than Jane in this example). FIG. 36B shows a simplified JSON structure showing the All Created Ticks and Comments Replies JSON nodes relating to Jane's Tick. Note that Tommy's comment (when he clicks on the Post button 3630A) will cause the OCE application to read/write to numerous RT Database JSON nodes such as, for example, the Comments Replies as well as others which have not been included in the simplified structure of FIG. 36B for the sake of simplicity. Another example of a JSON affected by the creation of a comment is the Total Comments For Each Tick, which keeps track of how many comments each TickID has, which again is not shown on FIG. 36 for the sake of simplicity.

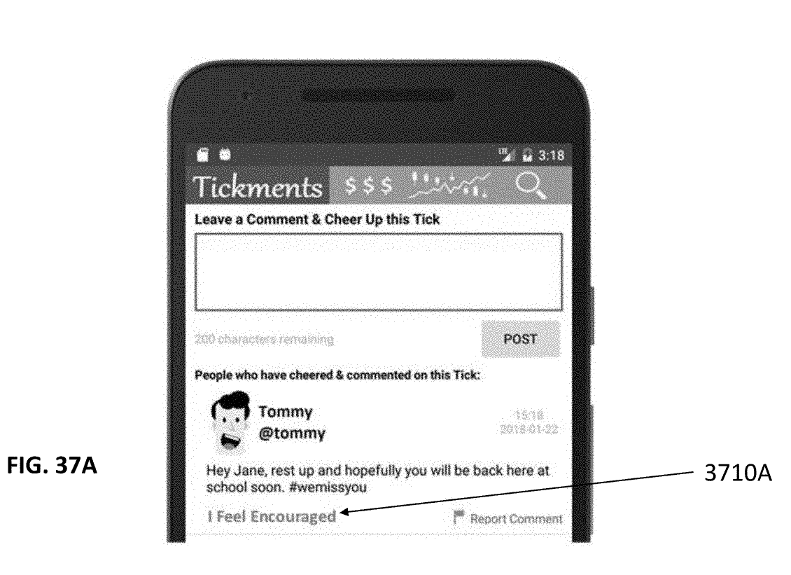

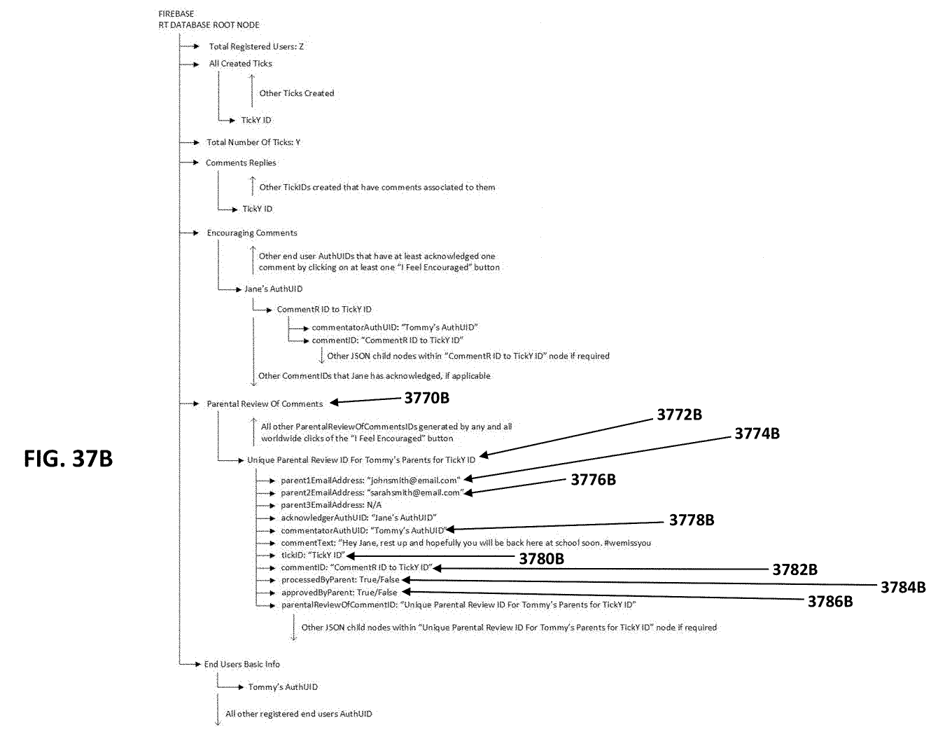

Jane may view the comments left in response to her Tick, for example, on a Comments Page, that may be generated by reading the Comments Replies JSON node and any other required JSON nodes to obtain pre-requisite/needed data from RT Database (in accordance with techniques known to those skilled in the art) to properly display information in a ListView (eg: an Android ArrayList with elements containing data) related to each comment to be displayed. FIG. 37A shows an exemplary user interface for displaying the Comments Page within the OCE application to the author of the Tick in question (i.e. Jane in this example). Because Jane is viewing comments to a Tick which she authored, she has the option of acknowledging the comment as positive by, for example, clicking the “I Feel Encouraged” (IFE) button 3710A. By clicking the IFE button, Jane acknowledges the commenting end user for their supportive and respectful comment, being Tommy in this example.

The consequences to the various JSON nodes in RT Database of Jane clicking the IFE button will now be described with reference to FIGS. 36B and 37B, which shows a simplified JSON structure showing, among other JSON nodes, the All Created Ticks, Comments Replies, and Encouraging Comments JSON nodes relating to Jane's Tick. When the IFE button is clicked, the OCE application obtains information (e.g. data from the specific ListView element where the IFE button is clicked on by Jane, Comments Page data, and FirebaseUser AuthUID data, since Jane is “authenticated” to Firebase and she is logged in to the OCE App) about the Tick and Comment such as, for example, TickID 3620B (obtained from the Comments Page data), CommentID 3630B (obtained from the ListView element), commentatorAuthUID 3640B (obtained from the ListView element), acknowledgerAuthUID 3650B (obtained from the Comments Page data with the value equal to the FirebaseUser AuthUID of Jane), CommentText 3660B (obtained from the ListView element), etc. . . . The OCE app then verifies whether CommentID already exists within RT Database's EncouragingComments/AcknowledgerAuthUID/CommentID child node structure. If the CommentID already exists, then Jane has already clicked the IFE button in response to this comment and the following steps are not performed. If the CommentID is not found (i.e. Jane has not previously acknowledged the comment) the OCE application will cause commentatorAuthUID, commentID and possibly other information relevant to be written to CommentRID to TickYID under the Encouraging Comments' AcknowledgerAuthUID JSON node. The OCE application will then read the End User's Basic Info JSON node for the commentatorAuthUID to retrieve information relevant to that user (Tommy in this example) such as, for example, his parents' email addresses. Finally, the OCE application then writes to the Parental Review of Comments JSON node 3770B. A new unique ParentalReviewOfCommentsID (for this example being “Unique Parental Review ID for Tommy's Parents for TickY ID” 3772B) may be generated within the Parental Review of Comments JSON node for the specific TickID and CommentID combination, which may contain information within child nodes relevant to the acknowledged comment such as, for example, any parents' email addresses 3774B, 3776B, acknowledgerAuthUID 3750B, commentatorAuthUID 3778B, commentText 3760B, TickID 3780B, CommentID 3782B, etc. as shown on FIG. 37B. JSON child nodes for processedByParent 3784B and approvedByParent 3786B may also be created under the ParentalReviewOfComments JSON node 3770B, which are both set to FALSE when first written by the OCE application.

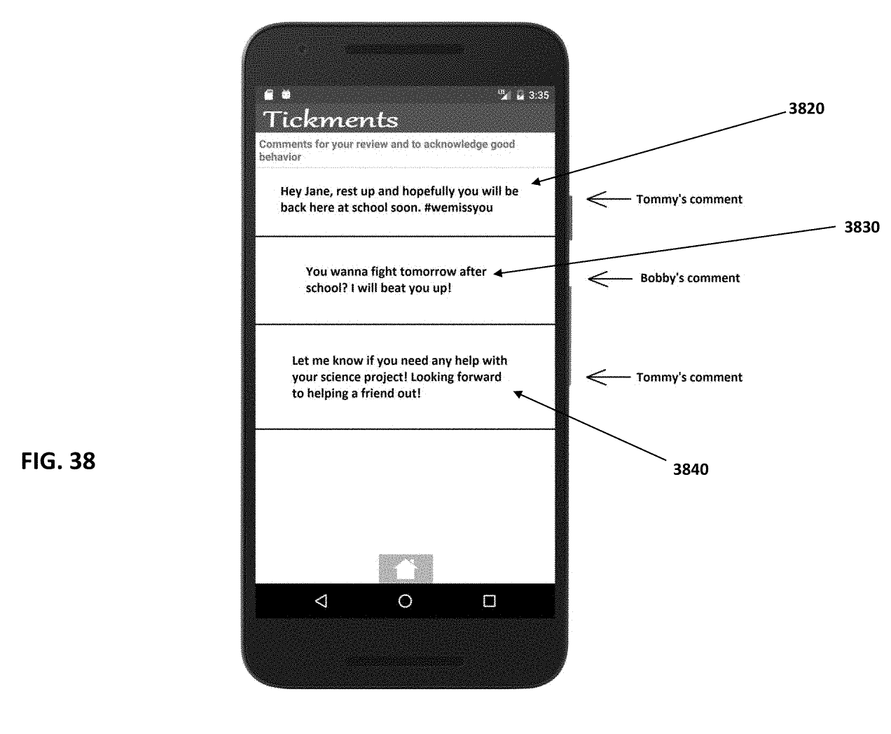

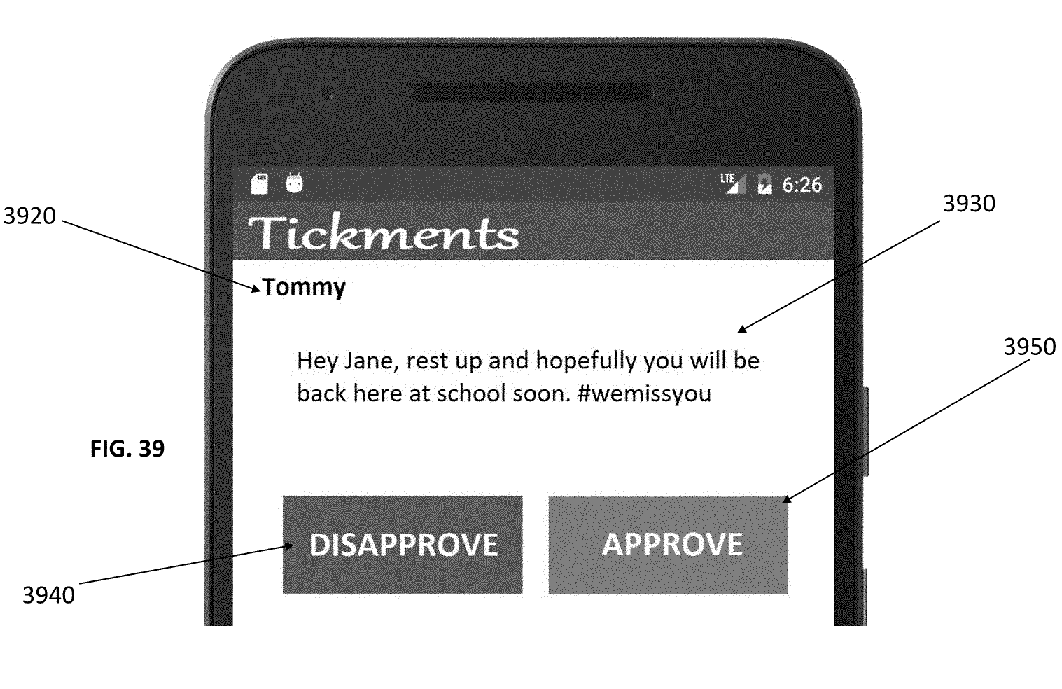

An exemplary process through which acknowledged comments may be validated will now be described with reference to FIGS. 38 and 39. When a parent signs in to the OCE application, they may be prompted (when they perhaps click on a button that will lead them to a new page within the OCE App) to view a list of acknowledged comments 3820, 3830, 3840 authored by any of their kids. This may be achieved, for example, by performing a query of the RT Database for matches between the parent's email address and email addresses appearing in the Parental Review Of Comments JSON node. Consider an extension of the example above with Jane and Tommy where John Smith (with email address johnsmith@email.com) is the registered parent to Tommy and another child named Bobby. When parent John is signed in to the OCE application, a user interface such as, for example, the one shown in FIG. 38 may be displayed to him (after perhaps clicking on a button that will lead him to the page shown on FIG. 38). In FIG. 38, three comments 3820, 3830, 3840 are displayed to John for review, with the top comment 3820 being Tommy's comment from the above example. Any comment retrieved by the query for which the processedByParent entry reads “FALSE” may be displayed. With returning reference to FIG. 37, Tommy's second parent, Sarah Smith, would also be prompted to view and approve Tommy's acknowledged comment as long as processedByParent reads FALSE.

John may click on a displayed comment, prompting him to approve or disapprove of the comment. An exemplary user interface for approving or disapproving of a comment is shown in FIG. 39. When John clicks into a comment (from FIG. 38), the name of the child who authored the comment 3920 may be retrieved from the End Users Basic Info JSON node (for example 3325 from FIG. 33) and displayed at the top of the screen above the content of the comment in question 3930. Having reviewed the comment, John may then approve (if he deems the comment to be respectful) or disapprove (if he deems the comment to be disrespectful) by clicking on the appropriate button 3940 or 3950.

With returning reference to FIGS. 34 and 37B, when a comment is approved, the processedByParent 3784B entry is set to TRUE. Additionally, the approvedByParent 3786B entry is set to TRUE and the comment's author is attributed a point by incrementing the pointsBalance 3450 and maxPointsEarned 3460 for that commentator's EndUserAuthID within the Points For Acknowledged Positive Comments JSON node. Incrementing values in the RT Database may, for example, be performed using Firebase Transactions. Conversely, when a comment is disapproved, the processedByParent 3784B entry is set to TRUE but the approvedByParent 3786B entry is set to FALSE and the pointsBalance 3450 and maxPointsEarned 3460 for that commentator's EndUserAuthID 3430 within the Points For Acknowledged Positive Comments JSON node 3420 are unaffected. Once the comment has been processed (i.e. the processedByParent entry reads TRUE), the comment will no longer appear in the ListView of FIG. 38 and consequently, when any parent of the comment's author is signed in to the OCE application, that particular comment will no longer appear for processing.

Upon processing a comment, a message may be displayed to the processing parent. For example, when a comment has been approved, an exemplary message may read “Thank you for acknowledging your child's good behaviour”. When a comment has been disapproved, an exemplary message may read “Please discuss with your child for learning opportunities”.

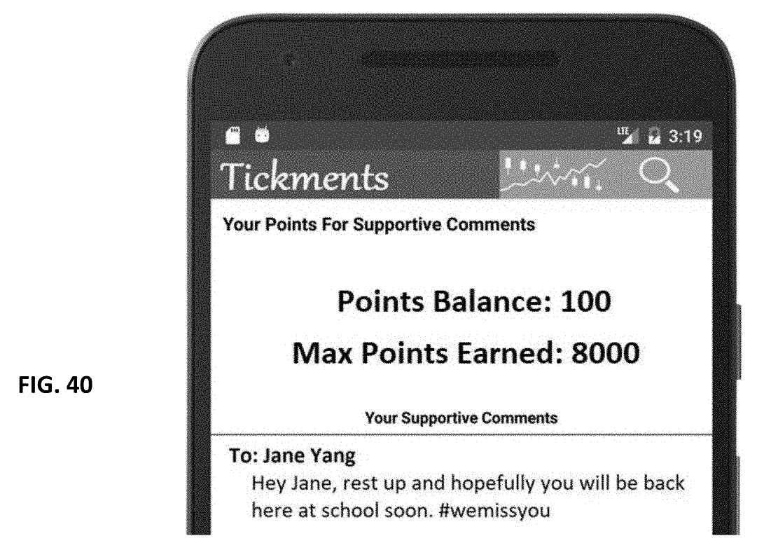

An end user, such as Tommy, may be able to view his points balance and max points earned within the OCE application. An exemplary user interface displaying the points balance and max points earned is shown in FIG. 40. This information may be retrieved from the RT Database within the Points For Acknowledged Positive Comments/AuthUID child node for Tommy's AuthUID 3430 (refer to FIG. 34). Within this exemplary user interface may also be displayed a scrollable list of previously approved supportive comments authored by the end user who is running the OCE application. Such a list of comments may be generated by querying the Parental Review of Comments JSON node within the RT Database for comments authored by the given end user and then filtering the retrieved comments from the query to only display retrieved comments that have the processedByParent and approvedByParent both set to TRUE. For each comment meeting that criteria, name of the author of the Tick, as well as the content of the comment may be retrieved (using techniques similar to those already described) for display within the exemplary user interface of FIG. 40.

The comment approval process described above may tie into the relationship score meter concept described earlier in the description in connection with FIGS. 28 and 29. Given that comments may be considered to be digital interactions, they may affect the relationship score meter for the end user at the time the comment is generated. Additionally, an encouraging comment that has been approved by a parent may further positively affect the commenting end user's relationship score meter at the time of approval.

There may be an OCE rewards administrator, similar to that described above in the context of engagement with other users within the OCE, that may review and scan the RT Database periodically for users' Points For Acknowledged Positive Comments and award coupons to end users that have met certain criteria. For example, the OCE rewards administrator may check the end user's Points for Acknowledged Positive Comments JSON node at the end of each day to determine which end users have met a certain threshold of points. Where an end user's points tally qualifies him or her for a reward, the OCE rewards administrator (or another automated OCE administrator type) may write a reward to the end user in question's RewardsCoupons JSON node (as described earlier in the description).

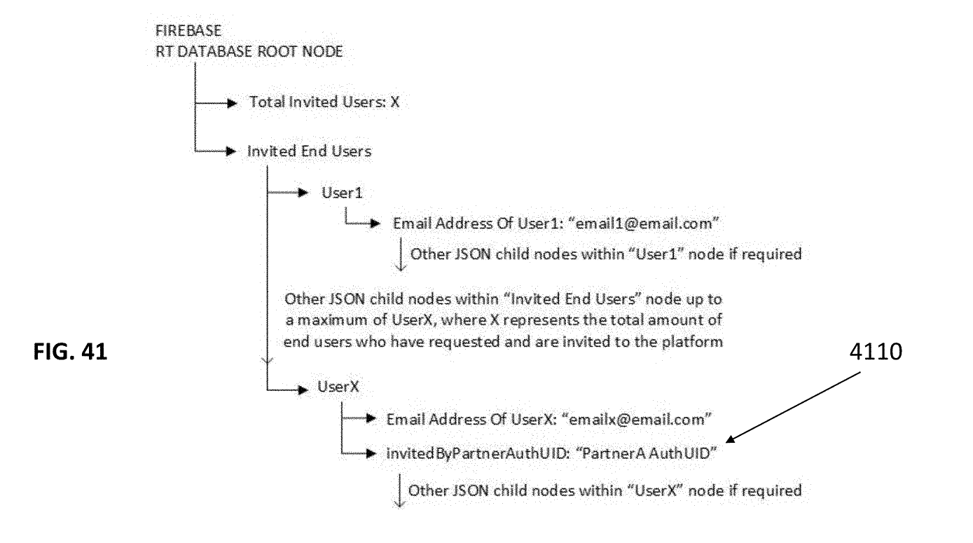

Another aspect of the present disclosure, relating to yet another method of incentivizing non-screen-related activities, will now be described with reference to FIGS. 41 to 43. This aspect of the disclosure encourages users to take a ‘recess break’ from their handheld device (through what will be referred to throughout this disclosure as the ‘recess platform’), leading to many of the benefits described above associated with engaging in activities that do not involve one's handheld device. Many of the functionalities of the recess platform overlap with the OCE platform described above and it may therefore be convenient for the recess platform to be integrated within the OCE platform. However, the recess platform may alternatively be independent of the OCE platform. For ease of illustration, an integrated recess platform will be described herein.

Recall that designated partners were introduced above in connection with administering the strict registration (i.e. one account per user) process for the OCE platform. The same designated partners may be called upon to administer the ‘recess challenges’ with their associated users. In order to link end users and their associated designated partners, additional information may be included in the JSON nodes caused to be written when a requesting user is validated and invited to join the OCE platform. Recall in FIG. 5, at step 549, once a requesting user has been granted access to the OCE Platform, a new JSON child node is created within the Invited End Users JSON node, containing that user's email address. This step 549 may also cause the AuthUID of the designated partner to be included within the invitedByPartnerAuthUID JSON child node (4110). With this association in place, the AuthUID of the inviting designated partner (e.g. PartnerA AuthUID) may be retrieved and written (by the OCE app) into the end user's End Users Basic Info JSON child node as the user's officialDesignatedPartnerAuthUID 4210 (as per methods and steps that have already been outlined and discussed). The writing of this JSON node may occur following completion of step 460 of the process through which an end user gains access to the platform.

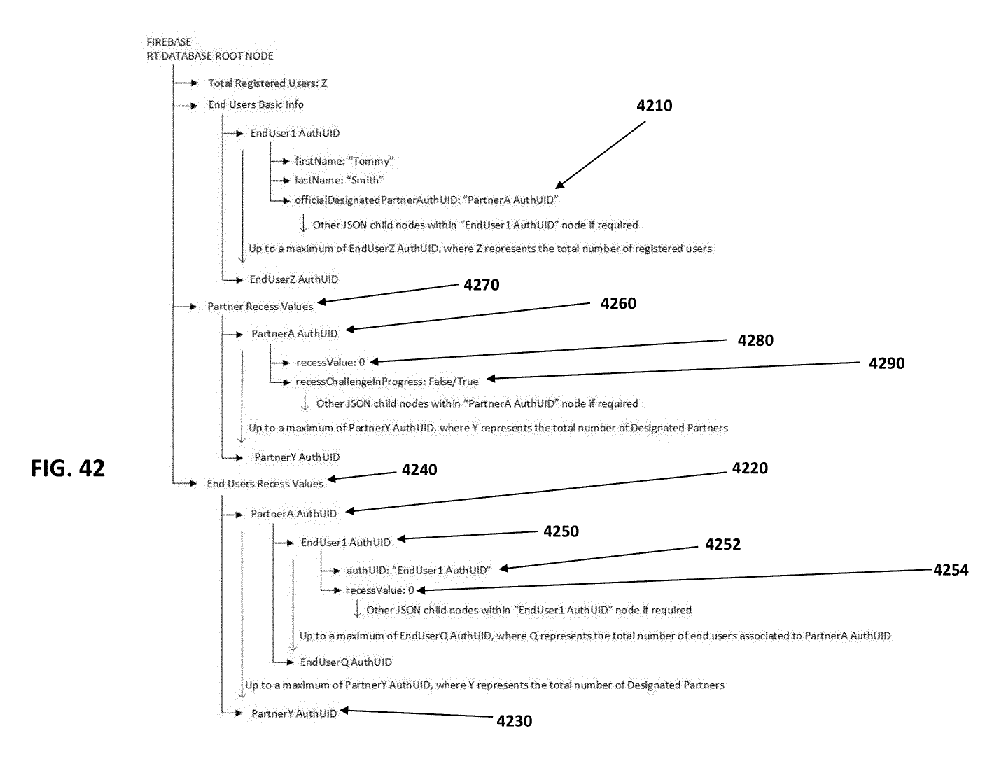

Note that the officialDesignatedPartnerAuthUID entry may change over time for a given end user. For example, if an end user changes schools and maintains access to the platform, the old school's AuthUID may be replaced with the AuthUID of the new school. Changes in official designated partners may be tracked in a variety of ways. For example, a user's location may be monitored to determine where he or she spends the majority of their time and if that location falls within the geographical location of a registered designated partner, that designated partner becomes that user's official designated partner for the purposes of the recess platform. Alternatively, an end user may be called upon to tap their handheld device to a partner's device, using near field communication technology, in order to make the association. Note also that an end user may also have multiple official designated partners. For example, an end user in high school may have a part time job and may also regularly attend a fitness club. In this case, the end user may be associated with each of the educational institution, the employer and the fitness institution if each of them was registered as a designated partner (i.e. RT Database→End Users Basic Info→EndUserZ AuthUID can have multiple JSON child nodes for each Designated Partner the end user is associated to). As a result, the same end user may hold a child node within multiple designated partner child nodes (e.g. 4220, 4230 of FIG. 42) within the End Users Recess Values JSON node 4240.

In order to be able to administer recess challenges, additional JSON nodes are required to be written, for example, upon completion of step 460 (for initializing the registered end user 4250 within the End Users Recess Values JSON node 4220) and also when the Designated Partner completes the partner registration process of FIG. 2 (for initializing the Designated Partner 4260 within the Partner Recess Values JSON node 4270). For example, FIG. 42 shows additional JSON nodes for Partner Recess Values 4270 and End Users Recess Values 4240. The AuthUID of each designated partner (e.g. 4260) will be written as a child node within the Partner Recess Values JSON node. Additional child nodes recess Value 4280 and recessChallengelnProgress 4290 are also included for each designated partner and will be described in greater detail below. The End Users Recess Values JSON 4240 will include a child node containing the AuthUID of each designated partner (e.g. 4220), which will in turn contain a child node containing the AuthUID for each of that designated partner's associated end users (e.g. 4250). Within the JSON for each end user may be included the end user's AuthUID 4252 and a recess Value 4254, which will be described in greater detail below.

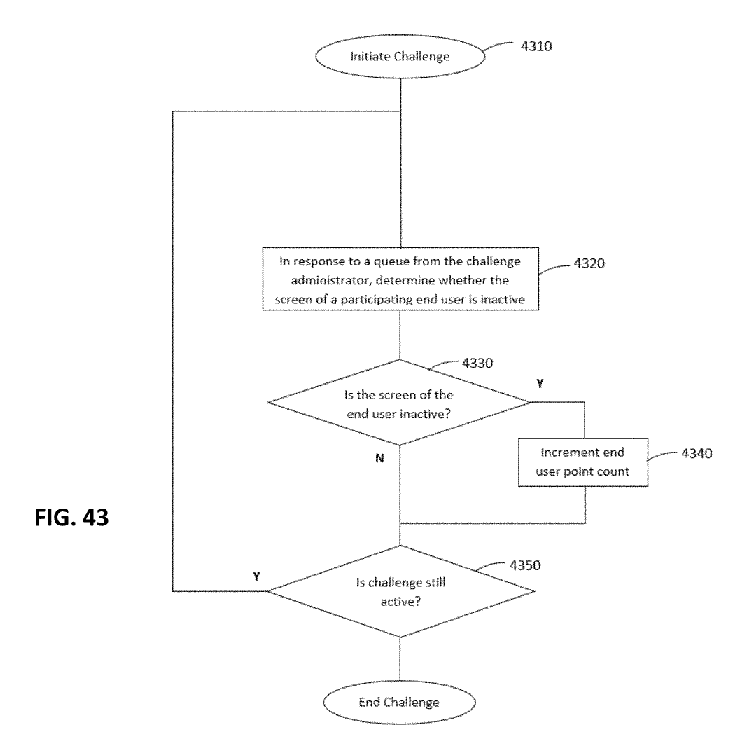

The steps of administering a recess challenge will now be described with reference to FIG. 43. The first step is for the challenge to be initiated 4310. A recess challenge may be initiated in a variety of ways. For example, a designated partner may initiate a recess challenge by engaging a ‘start challenge’ button on their handheld device. Alternatively, challenges may be initiated in accordance with pre-established time schedules. For example, an educational institution designated partner administering the challenge may pre-arrange the initiation of challenges to coincide with the beginning of the institution's recess period (which would typically start at the same time every day, e.g., lunch time at work or lunch time at school both start at 12 pm sharp).

As will be discussed in greater detail below, end users' success during the challenge will be monitored for the purpose of rewarding those users with the greatest performance. When a challenge is initiated, recessChallengelnProgress value 4290 for the challenge administrating designated partner is changed from FALSE to TRUE. Throughout the challenge, the challenge administrator may issue queues that will cause the end users' devices to be checked for screen activity. Those queues may be triggered, for example, by the challenge administrator engaging a button on their handheld devices (subsequent to “challenge initiation”). Alternatively, queues may be programmed to initiate randomly throughout the duration of the challenge. When a queue is issued, the challenge administrator's recess Value 4280 within their Partner Recess Values JSON node 4270 is incremented by 1. For example, in FIG. 42, if Partner A were administering the challenge and were to issue its first queue, their recess Value 4280 (which was initially set to zero) would be incremented to 1. At any given time throughout a recess challenge, the partners' recess Value corresponds to the total amount of queues that have been issued during the current recess challenge.

A monitoring mechanism, such as for example an RT Database listener attached to the challenge administrator's JSON node (e.g. 4260 of FIG. 42) within the Partner Recess Values parent JSON node 4270, is used to monitor for changes in the recess Value 4280 to notify the OCE App of all associated end users when a queue has been issued.

At steps 4320 and 4330, in response to a queue issued from the challenge administrator, a determination is made (by the OCE app) for each participating end user as to whether the screen of the device is on or off (i.e. active or inactive). This determination may be made, for example, on modern Android devices by using the android.view.Display getState( ) method/function which will indicate whether a given device screen is on or off. Similar functions may be used to determine screen state for other technological platforms. If the device screen is determined to be off (or inactive), step 4340 is undertaken whereby a point count for the end user is incremented by 1 and the method then proceeds to step 4350. If the device screen is determined to be on (or active), then the method proceeds directly to step 4350 without incrementing the end user's point count. The point count in this exemplary example is the end user's recess Value 4254.

Step 4350 determines whether the challenge has ended. A challenge may be ended, for example, by the challenge administrator engaging an ‘end challenge’ button on their handheld device. Alternatively, challenges may be pre-set to end at specific times, for example, corresponding with the end of a school's recess period or work lunch break, or set to last for a specific duration of time (e.g. 10 minutes). Once a challenge has ended, the partner's recessChallengelnProgress value 4290 is caused to be changed to FALSE, causing end users' recess Value to be unaffected by any potential subsequent queues (i.e. 4320, 4330, and 4340 would stop executing for this challenge).

With the challenge now ended, end users' recess Values may be queried to determine whether any end users should receive a reward/coupon. The higher the recess Value for a given end user, the less he or she was interacting with their handheld device throughout the recess challenge. It will be appreciated that the highest recess Value an end user may have achieved in this example is the recess Value of the challenge administrator at the end of the challenge. Rewards/coupons may be issued only to those end users whose recess Value equals that of the challenge administrator. Alternatively, end users having a recess Value that is at least a certain percentage (e.g. 90%) of the recess Value of the challenge administrator may be eligible for a reward/coupon. It will be appreciated that other suitable criteria may be used to reward the end users. The rewards/coupons may be tracked and administered in accordance with the description provided above.

Once all rewards coupons have been awarded in connection with a given recess challenge, changes to certain JSON nodes may be made to ensure that the relevant values are reset and ready for a subsequent challenge. For example, with reference to FIG. 42, where Partner A was the challenge administrator and all rewards coupons have been awarded in connection with the challenge, the recess Value 4254 for each end user within the Partner A 4220 within the End Users Recess Values 4240 may be reset to zero. Also, the recess Value of Partner A within the Partner Recess Values JSON node is set back to zero in order to be ready for the next challenge.

As an alternative to using the recess challenges concept to ensure that users are avoiding screen time during periods of time for non-screen time would be healthier, the concept could also be used to ensure that users aren't communicating or using their phones at times when they are not supposed to. For example, a recess challenge could start and end at the beginning and end, respectively, of a school test when users should not be communicating with each other or using their handheld devices to access information. Monitoring for screen activity during this period of time may permit recess administrators to determine if any users cheated by using their phones during the test. As a further alternative, the recess challenge concept may be used to ensure that employees are not engaging in personal activities using their handheld devices during work hours.

To help motivate users or showcase certain high-achieving users, a “leaderboard” may be established to show which users for a given designated partner have earned the most rewards from recess challenges. For example, a leaderboard may display the users associated with a given educational institute in decreasing order of rewards earned from recess challenges throughout the school year.

It will be appreciated that the teachings described above relating to real world challenges may be combined with the teachings relating to recess challenges to help ensure the authenticity of the real world interactions/challenges.

Throughout this disclosure, certain brands and celebrities were references for demonstrative purposes only. Any such reference should not be taken to insinuate the existence of any relationship between the applicant and those brands/celebrities.

What is claimed is:

1. A method of restricting user registration to an online communication environment, the method comprising the steps of:
a. obtaining a unique identifier from a user requesting to register to the online communication environment;
b. comparing the unique identifier to a database containing unique identifiers of previously-registered users; and,
c. denying registration of the requesting user if the requesting user's unique identifier is contained in the database.

2. The method of claim 1 wherein the unique identifiers are facial pictures of the users.

3. The method of claim 1 wherein the unique identifiers are users' social insurance numbers.

4. The method of claim 1 wherein the unique identifiers are finger prints of the users.

5. A method of preventing online bullying among users of an online communication environment, the method comprising the steps of:
a. maintaining a list of terms that a user considers offensive;
b. comparing terms contained in an online comment directed to the user to the terms contained in the list of terms; and,
c. restricting visibility to the comment if it contains one or more terms from the list of offensive terms.

6. The method of claim 5 wherein the list of terms is generated from input by the user.

7. The method of claim 5 further comprising the step of alerting a parent of an author of the comment if the comment contains one or more terms from the list of offensive terms.

8. A method of alerting a user of an online communication environment of signs of decreasing mental well-being in the user, the method comprising the steps of:
a. awarding points to the user based on their digital interactions and non-digital interactions, wherein the points awarded are decremented according to a pre-determine schedule;
b. monitoring the user's point count over time to establish the user's maximum point count; and,
c. alerting the user if the user's point count falls below a predetermined point interval of the user's maximum point count.

9. The method of claim 8 wherein points are decremented at the end of each day.

10. The method of claim 8 wherein points awarded for non-digital interactions are decremented at a lesser rate than points awarded for digital interactions.

11. The method of claim 10 wherein points awarded for non-digital interactions are decremented at a rate of one tenth the rate that points awarded for digital interactions are decremented.

12. A method of identifying non-digital interactions between two or more users of an online platform, the method comprising the steps of:
a. tracking a physical location of the technological devices of the two or more users over a period of time;
b. periodically comparing the physical locations of the two or more users' technological devices to determine whether the devices are within a pre-established threshold distance; and,
c. periodically monitoring another criterion related to each user to determine true participation in the non-digital interaction.

13. The method of claim 12 wherein the non-digital interaction involves the users playing a sport together.

14. The method of claim 13 wherein the other criterion related to each user is their heart rate.

15. A method of promoting positive interactions among users of an online communication environment, the method comprising the steps of:
a. presenting to a comment verifier an online comment that has been identified as encouraging by a user of the online communication environment; and,
b. in response to an indication from the comment verifier validating the comment as encouraging, recognizing an authoring user of the comment.

16. The method of claim 15 wherein the comment verifier is a parent of the authoring user.

17. A method of promoting non-digital activities in users of an online communication environment, the method comprising the steps of:
a. receiving a signal from an administrator;
b. in response to the signal from the administrator, determining the status of a technological device of a user; and
c. awarding the user if the status of their technological device is inactive.

18. The method of claim 17 wherein the signals from the administrator are generated automatically.

19. The method of claim 18 wherein the signals from the administrator are generated according to a predetermined schedule.
